(19) United States
(12) Patent Application Publication
(10) Pub. No.: US 2013/0271580 A1
(43) Pub. Date: Oct. 17, 2013

(54) 3-DIMENSIONAL IMAGE CAPTURING METHOD

(71) Applicants: Hirofumi Tahara, Miura (JP); Masaya Kosaka, Tokyo (JP); Toru Fujii, Tokyo (JP); Tsuneyuki Kubo, Tokyo (JP)

(72) Inventors: Hirofumi Tahara, Miura (JP); Masaya Kosaka, Tokyo (JP); Toru Fujii, Tokyo (JP); Tsuneyuki Kubo, Tokyo (JP)

(73) Assignee: OLYMPUS MEMORY WORKS CORP., Tokyo (JP)

(21) Appl. No.: 13/991,177

(22) PCT Filed: Dec. 29, 2010
(86) PCT No.: PCT/JP2010/007619

§ 371 Date: Jun. 3, 2013

(51) Int. Cl. H04N 13/02

(52) U.S. Cl. CPC H04N 13/0203
USPC 348/49

(57) ABSTRACT

The present invention is a 3-dimensional image capturing method and a 3-dimensional image capturing apparatus for capturing a 3-dimensional image including a left eye image and a right eye image that are 2-dimensional images having parallax with each other. In the invention, an optical axis of an image capturing optical system of the image capturing apparatus is shifted between a first optical axis and a second optical axis whose image capturing ranges overlap at least partly, without moving the image captuing apparatus itself, and in the shift of the optical axis, one of the left eye image and the right eye image is captured at the timing when the optical axis of the image capturing optical system is being the first optical axis, and the other of the left eye image and the right eye image is captured at the timing when the optical axis of the image capturing optical system is being the second optical axis.

### TECHNICAL FIELD

The present invention relates to a 3-dimensional image capturing method for capturing 3-dimensional image data for stereoscopic view using an image capturing apparatus. The 3-dimensional image includes a left eye image and a right eye image that are 2-dimensional images having parallax with each other. The present invention also relates to a 3-dimensional image capturing apparatus for capturing 3-dimensional image data for stereoscopic view including a left eye image and a right eye image that are 2-dimensional images having parallax with each other.

### BACKGROUND ART

Conventionally, 3-dimensional image capturing apparatuses for capturing 3-dimensional image data for stereoscopic view have been known. The 3-dimensional image includes a left eye image and a right eye image that are 2-dimensional images having parallax with each other. Such 3-dimensional image capturing apparatus have been configured with the twin-lens system. That is, a left-side image capturing optical system for capturing a left eye image and a right-side image capturing optical system for capturing a right eye image are provided separately, and the 2 image capturing optical systems are disposed with a predetermined distance from each other so that images having parallax with each other can be captured. Such a twin-lens system 3-dimensional image capturing apparatus is disclosed in Patent Document 1 for example.

Meanwhile, there are a case in which the optical axes of the left and right image capturing systems of the twin-lens system are disposed in parallel, and a case in which they cross along the way. When the optical axes are in parallel, it is called the “parallel view method”, which has a characteristic that the eyes of the observer of the 3-dimensional image are relatively less strained. On the other hand, when the optical axes are crisscrossed, it is called the “cross view method”, which has a characteristic that a 3-dimensional image abound in stereoscopic effects can be obtained.

Here, the layout of optical axes in the parallel view method in conventional arts is presented in FIG. 1A, and the layout of the optical axes in the cross view method is presented in FIG. 1B. In the parallel view method presented in FIG. 1A, a subject is observed under a condition where the directions of lines of sight from the 2 viewpoints corresponding to the left and right eyes of an observer are parallel. For example, in actual image shooting, in the case of capturing 3-dimensional image data, a left-eye camera 81 for capturing an left eye image to be directed to the left eye of an observer and a right-eye camera 82 for capturing an right eye image to be directed to the right eye of the observer are disposed with a predetermined distance in the real space, and the shooting optical axes of the left-eye camera 81 and the right-eye camera 82 are set parallel. Meanwhile, the distance between the left-eye camera 81 and the right-eye camera 82 is often set as, for example, about 6.5 cm based on the distance between human pupils. However, it may be set as a shorter distance.

On the other hand, in the case of the cross view method presented in FIG. 1B, a left-eye camera 83 for capturing an left eye image to be directed to the left eye of an observer and a right-eye camera 84 for capturing an right eye image to be directed to the right eye of the observer are disposed with a predetermined distance in the real space, and so that the shooting optical axes of the left-eye camera 83 and the right-eye camera 84 are crisscrossed. In the cross view method, the distance between the left-eye camera 83 and the right-eye camera 84 is often set as about 6.5 cm in the same manner as described above. However, it may be set as a shorter distance. In addition, the position at which the lines of sights (optical axes) cross is set, normally, about 1-3 m ahead of the left-eye camera 83 and the right-eye camera 84.

### CITATION LIST

### Patent Literature

Patent Document 1: Japanese Patent Application Publication No. H03-138634

### SUMMARY OF INVENTION

The present invention is a 3-dimensional image capturing method and a 3-dimensional image capturing apparatus for capturing a left eye image and a right eye image in time divisional way while shifting the optical axis of a monocular image capturing optical system, and/or, a 3-dimensional image capturing method and a 3-dimensional image capturing apparatus with which the spatial layout of an optical axis for taking a light-eye image and an optical axis for taking a right eye image (optical axis layout) can be varied.

More specifically, a 3-dimensional image capturing method of the present invention is a method for capturing a 3-dimensional image including a left eye image and a right eye image that are 2-dimensional images having parallax with each other, with which the optical axis of one image capturing optical system of the image capturing apparatus is shifted between a first optical axis and a second optical axis whose image capturing ranges overlap at least partly, without moving the image capturing apparatus itself, and in the shift of the optical axis, one of the left eye image and the right eye image is captured at the timing when the optical axis of the image capturing optical system is being the first optical axis, and the other of the left eye image and the right eye image is captured at the timing when the optical axis of the image capturing optical system is being the second optical axis.

Meanwhile, a 3-dimensional image capturing apparatus of the present invention is a 3-dimensional image capturing apparatus for capturing a 3-dimensional image including a left eye image and a right eye image that are 2-dimensional images having parallax with each other, having an image capturing optical system; an image capturing element on which light passing through the image capturing optical system forms an image; an optical axis shifting mechanism to shift, without moving the image capturing apparatus itself, an optical axis of the image capturing optical system between a first optical axis and a second optical axis whose image capturing ranges overlap at least partly; and an image capturing circuit to capture, in the shift, one of the left eye image and the right eye image at timing when the optical axis of the image capturing optical system is being the first optical axis and to capture the other of the left eye image and the right eye image at timing when the optical axis of the image capturing optical system is being the second optical axis.

Meanwhile, a 3-dimensional image capturing apparatus of the present invention is a 3-dimensional image capturing apparatus for capturing a 3-dimensional image including a left eye image and a right eye image that are 2-dimensional images having parallax with each other, having an image capturing element; one image capturing optical system that makes incident light form an image on the image capturing element; a first optical axis deflecting member disposed on an optical axis of the image capturing optical system closer to the subject with respect to the image capturing optical system to change the direction of the optical axis of the image capturing optical system; an optical axis shifting mechanism to shift, without moving the image capturing apparatus itself, an optical axis of the image capturing optical system between a first optical axis and a second optical axis whose image capturing ranges overlap at least partly, by moving the first optical axis deflecting member; and an image capturing circuit to capture, in the shift of the optical axis, one of the left eye image and the right eye image at timing when the optical axis of the image capturing optical system is being the first optical axis and to capture the other of the left eye image and the right eye image at timing when the optical axis of the image capturing optical system is being the second optical axis.

Meanwhile, a 3-dimensional image capturing apparatus of the present invention may be configured to use, instead of the first optical axis deflecting member of in the con-figuration described above, an optical axis shifting member to shift the optical axis of the image capturing optical system between the first optical axis and the second optical axis whose image capturing ranges overlap at least partly without moving the image capturing apparatus itself, by swinging the orientation of the image capturing optical system.

Meanwhile, a 3-dimensional image capturing apparatus of the present invention may be configured to use, instead of the configuration in which the angles of the first optical axis deflecting member or the image capturing optical system are swung, an optical axis shifting member to shift the optical axis of the image capturing optical system between the first optical axis and the second optical axis whose image capturing ranges overlap at least partly without moving the image capturing apparatus itself, by switching the position of the image capturing optical system.

Meanwhile, the configuration may also be made to use an optical axis shifting member to shift the optical axis of the image capturing optical system between the first optical axis and the second optical axis whose image capturing ranges overlap at least partly without moving the image capturing apparatus itself, by using a polarization switching element to switch the polarization property of incident light to the image capturing optical system and a polarization optical path splitting element, these are disposed on the optical axis of the image capturing optical system, to split the optical path into a plurality according to the property of the polarization and by switching the property of the polarization using the polarization switching element.

Meanwhile, a 3-dimensional image capturing apparatus of the present invention is a 3-dimensional image capturing apparatus for capturing a 3-dimensional image including a left eye image and a right eye image that are 2-dimensional images having monocular or binocular image capturing optical system that has a first optical axis for capturing one of a left eye image and a right eye image and a second optical axis for capturing the other of a left eye image and a right eye image; and an optical axis layout setting mechanism to change a relative angle of the first optical axis and the second optical axis of the image capturing optical system. In this case, the angle can be set automatically according to the distance to the subject.

### BRIEF DESCRIPTION OF DRAWINGS

FIG. 1A is a diagram presenting the layout of optical axes in the parallel view method in conventional arts.

FIG. 1B is a diagram presenting the layout of optical axes in the cross view method in conventional arts.

FIG. 2 is a block diagram presenting the configuration of an image capturing apparatus of the first embodiment of the present invention.

FIG. 3 is a diagram illustrating the operations of an optical axis shifting mechanism and an optical axis layout setting mechanism in the case of the cross view method.

FIG. 4 is a diagram illustrating the operations of an optical axis shifting mechanism and an optical axis layout setting mechanism in the case of the parallel view method.

FIG. 5 is a diagram illustrating the operations of an optical axis shifting mechanism and an optical axis layout setting mechanism in the case of a V-shape.

FIG. 6 is a diagram illustrating the case in which the angles of a first optical axis deflecting member and a second optical axis deflecting member do not swing.

FIG. 7 is a diagram compiling characteristics and the like of the layout modes in capturing a 3-dimensional image.

FIG. 8 is a flowchart illustrating the setting method of the layout modes.

FIG. 9 is a diagram presenting the configuration an image capturing apparatus specifically laying out an image capturing element, image capturing optical system, a first optical axis deflecting member and a second optical axis deflecting member.

FIG. 10 is a flowchart illustrating a process tot capture a 3-dimensional image using an image capturing apparatus.

FIG. 11 is a diagram presenting shooting modes for attitudes of the image capturing apparatus.

FIG. 12 is a diagram illustrating an example of an image capturing apparatus of a variation example of the first embodiment.

FIG. 13 is a diagram illustrating shooting modes for attitudes of the image capturing apparatus of the variation example.

FIG. 14 is a diagram illustrating the configuration of an image capturing apparatus of the second embodiment of the present invention.

FIG. 15A is a diagram presenting the configuration of an image capturing apparatus specifically laying out a first optical axis deflection member and a second optical axis deflecting member having an image capturing element and an image capturing optical system inside.

FIG. 15B is a diagram presenting the configuration of an image capturing apparatus specifically laying out a first optical axis deflection member and a second optical axis deflecting member having an image capturing element and an image capturing optical system inside.

FIG. 16 is a diagram illustrating the setting of the optical axis layout in the case of the cross view method in the image capturing apparatus of the second embodiment.

FIG. 17 is a diagram illustrating the setting of the optical axis layout in the case of the parallel view method in the image capturing apparatus of the second embodiment.

FIG. 18 is a diagram illustrating the setting of the optical axis layout in the case of the V-shape type in the image capturing apparatus of the second embodiment.

FIG. 19 is a diagram illustrating the case in which the angle of an optical axis deflecting member is not changed in the image capturing apparatus of the second embodiment.

FIG. 20 is a diagram presenting the configuration of an image capturing apparatus of the third embodiment of the present invention.

FIG. 21 is a schematic diagram of a rotation unit.

FIG. 22 is a diagram presenting a specific configuration example of an image capturing apparatus.

FIG. 23 is a diagram illustrating the setting of the optical axis layout in the case of the cross view method in the image capturing apparatus of the third embodiment.

FIG. 24 is a diagram illustrating the setting of the optical axis layout in the case of the parallel view method in the image capturing apparatus of the third embodiment.

FIG. 25 is a diagram illustrating the setting of the optical axis layout in the case of the V-shape in the image capturing apparatus of the third embodiment.

FIG. 26A is a diagram illustrating an example of changing the shooting timing in the case in which the image capturing apparatus is held horizontally.

FIG. 26B is a diagram illustrating an example of changing the shooting timing in the case in which the image capturing apparatus in held vertically.

FIG. 27A is diagram illustrating an example of a captured image in the case in which the image capturing apparatus is held horizontally.

FIG. 27B is a diagram illustrating an example of captured image in the case in which the image capturing apparatus is held vertically.

FIG. 28 is a diagram presenting the configuration of an image capturing apparatus of the fourth embodiment of the present invention.

FIG. 29 is a diagram presenting the configuration of a rotation unit in detail.

FIG. 30 is a diagram illustrating the setting of the optical axis layout in the case of the cross view method in the image capturing apparatus of the fourth embodiment.

FIG. 31 is a diagram illustrating the setting of the optical axis layout in the case of the parallel view method in the image capturing apparatus of the fourth embodiment.

FIG. 32 is a diagram illustrating the fifth embodiment of the present invention.

FIG. 33 is a diagram illustrating the layout for capturing a 3-dimensional image of a subject by the cross view method of the image capturing apparatus.

FIG. 34 is a diagram illustrating the layout for capturing a 3-dimensional image of a subject by the parallel view method of the image capturing apparatus.

FIG. 35 is a diagram illustrating the layout for capturing a 3-dimensional image of a subject by the V-shaped layout of the image capturing apparatus.

FIG. 36 is a diagram illustrating the layout for capturing a 3-dimensional image of a subject by the cross view method being a variation example of the fifth embodiment.

FIG. 37 is a diagram illustrating the layout for capturing a 3-dimensional image of a subject by the parallel view method being a variation example of the fifth embodiment.

FIG. 38 is a diagram illustrating the layout for capturing a 3-dimensional image of a subject by the V-shaped layout being a variation example of the fifth embodiment.

FIG. 39 is a diagram illustrating the sixth embodiment of the present invention.

FIG. 40 is a diagram illustrating the birefringence of a calcite and the like for example as an example of a polarization optical path splitting element.

FIG. 41 is a diagram presenting an example of known Wollaston prism as another example of a polarization optical path splitting element.

FIG. 42 is a diagram illustrating an operation of liquid crystal switching the attribution of deflection as an example of a polarization switching element.

FIG. 43 is a diagram illustrating an operation of liquid crystal switching the attribution of deflection as an example of a polarization switching element.

FIG. 44 is a diagram presenting the arrangement of elements along the optical axis.

FIG. 45 is a flowchart illustrating a 3-dimensional image capturing method of the sixth embodiment.

FIG. 46 is a diagram presenting an example of the case of capturing a 3-dimensional image by the cross view method by the image capturing apparatus of the sixth embodiment.

FIG. 47 is a diagram presenting an example of the case of capturing a 3-dimensional image by the parallel view method by the image capturing apparatus of the sixth embodiment.

FIG. 48 is a diagram illustrating an example of disposing a polarization switching element and a polarization optical path separation element in front of the image capturing system.

FIG. 49 is a diagram illustrating the configuration in the case in which a weight is added to the adopter.

FIG. 50A is a diagram presenting an example of the case in which the image capturing apparatus is held horizontally.

FIG. 50B is a diagram presenting an example of the case in which the image capturing apparatus is held vertically.

FIG. 51 is a diagram illustrating the configuration of the adopter.

FIG. 52 is a diagram illustrating a first optical axis deflecting member used in the seventh embodiment.

FIG. 53 is a time series graph of changes of the angle of the first optical axis deflecting member.

FIG. 54 is an oblique perspective view presenting image capturing by an image capturing apparatus of the seventh embodiment schematically.

FIG. 55 is a diagram presenting the situation of capturing an image of a con-figuration having a cube in the distant view and a sphere in the near view by the image capturing apparatus of the seventh embodiment.

FIG. 56 is a diagram presenting an image captured in the situation presented in FIG. 55 by the image capturing apparatus of the seventh embodiment.

FIG. 57 is a diagram illustrating the manner in which a plurality of parallax images presented in FIG. 56 are observed using a known lenticular technique.

FIG. 58 is a diagram in which a lenticular lens and a base material are joined with position adjustment with each other.

FIG. 59 is a diagram illustrating a first optical axis deflecting member used in the eighth embodiment being a reflective member that vibrates with 2 axes.

FIG. 60 is a diagram presenting the relationship between the vibration phase around the X axis and the vibration phase around the Y axis of the first optical axis deflecting member realized by an optical axis shifting circuit.

FIG. 61 is a diagram in which the timing of image capturing is plotted on the theta x-theta y plane.

FIG. 62 is a diagram presenting the shift of the optical axis, which shows that the optical axis performs precession according to the movement of the reflective plane.

FIG. 63 is a diagram presenting a captured image in the case in which the image capturing is performed once every T/8 period by an image capturing circuit in the precession of the light axis.

FIG. 64 is a diagram illustrating the configuration of a display used to observe the image presented in FIG. 63.

FIG. 65 is a diagram illustrating the configuration in which a light source having a smaller or equal area than the area of each sub pixel is provided.

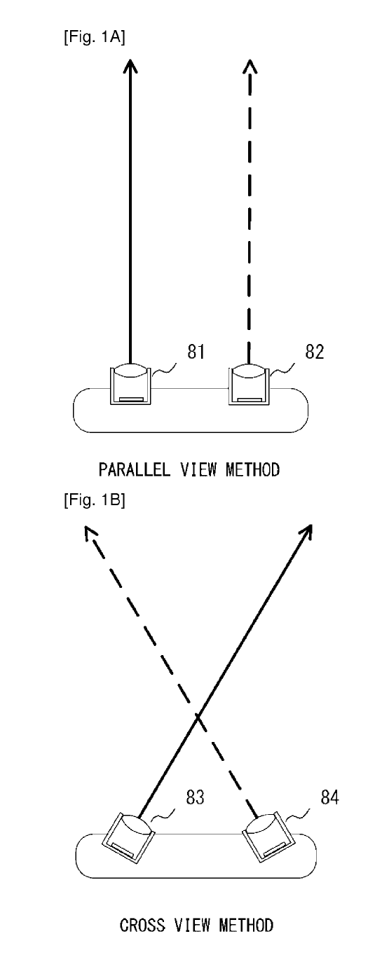

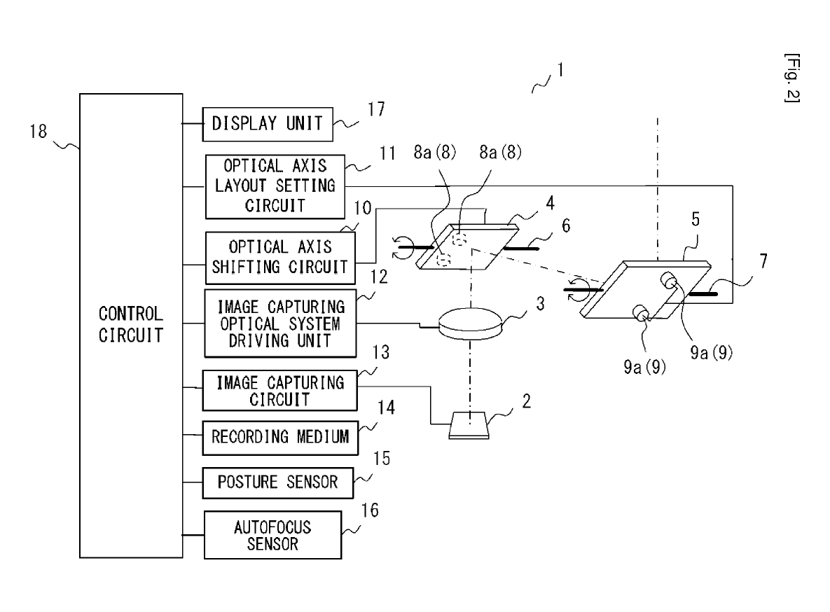

### DESCRIPTION OF EMBODIMENTS

Hereinafter, embodiments of the present invention are described based on drawings.

### First Embodiment

FIG. 2 is a block diagram presenting the configuration of an image capturing apparatus of the first embodiment.

In FIG. 2, an image capturing apparatus 1 is a 3-dimensional image capturing apparatus for capturing a 3-dimensional image including a left eye image and a right eye image that are 2-dimensional images having parallax with each other. The image capturing apparatus 1 has an image capturing element 2, an image capturing optical system 3, a first optical axis deflecting member 4, a second optical axis deflecting member 5, an optical axis shifting circuit 10, an optical axis layout setting circuit 11, an image capturing optical system driving unit 12, an image capturing circuit 13, a recording medium 14, an attitude sensor 15, an auto focus sensor 16, a display unit 17, and a control circuit 18.

Here, as the image capturing element 2, for example, a photoelectric conversion element such as a CCD (Charge Coupled Device) sensor and a CMOS (Complementary Metal Oxide Semiconductor) can be used. In addition, as the image capturing optical system 3, for example, a single focus lens, a zoon lens and the like can be used.

The first optical axis deflecting member 4 is disposed on the optical axis of the image capturing optical system 3, at a position closer to a photographic subject with respect to the image capturing optical system 3, and has a mechanism to change the direction of the optical axis of the image capturing optical system 3. In addition, the second optical axis deflecting member 5 is disposed on the optical axis of the image capturing optical system 3, at a position closer to the subject with respect to the first optical axis deflecting member 4, and has a mechanism to change the direction of the optical axis, as well as the first optical axis deflecting member 4. In addition, a minor , or a reflective member, is adopted as each of the first optical axis deflecting member 4 and the second optical axis deflecting member 5. In addition, the first optical axis deflecting member 4 is capable of changing its angle around an axis 6, and the second optical axis deflecting member 5 is also capable of changing its angle around an axis 7.

The optical axis shirting circuit 10 is a circuit that provides a control signal to the driving unit of the first optical axis deflecting member 4, and the optical axis layout setting circuit 11 is a circuit that provides a control signal to the second optical axis deflecting member 5. These circuit operations are described later.

The image capturing optical system driving unit 12 drives the image capturing optical system 3, and performs the focusing operation, the zooming operation and the like. In addition ,the image capturing circuit 13 outputs an image capturing signal at a predetermined timing to the image capturing element 2, and obtains image data of the subject that is not shown in the drawing from the image capturing element 2. In addition, the recording medium 14 is constituted by a flash memory for example, and records the image capturing data obtained by the image capturing element 2.

The attitude sensor 15 is constituted by a gravity sensor for example, and detects the attitude of the image capturing apparatus 1. The photographer can select the composition of the horizontally long shooting screen or the composition of the vertically long shooting screen, depending on which attitude to hold the image capturing apparatus 1. That is, the horizontally long composition can be set by holding the image capturing apparatus 1 horizontally, and the vertically long composition can be set by holding the image capturing apparatus 1 vertically.

The auto focus sensor 16 obtains distance information to the subject, and uses it for setting a layout mode described later. In addition, the display unit 17 is a glasses-free 3-dimensional display of the known parallax barrier system, for example, and the operator can observe the captured 3-dimensional image stereoscopically without 3D glasses.

In addition, the optical axis shifting circuit 10, the optical axis layout setting circuit 11, the image capturing optical system driving circuit 12, the image capturing circuit 13, the recording medium 14, the attitude sensor 15, the auto focus sensor 16, and the display unit 17 are connected to the control circuit 18 via signal lines, and are controlled according to control signals from the control circuit 18.

Next, in the configuration described above, the configurations of the first optical axis deflecting member 4 and the second optical axis deflecting member 5 are described.

First, the first optical axis deflecting member 4 is a reflective member whose surface is an optical reflective surface (for example, an aluminum coated mirror, a multilayer reflective mirror and the like), and 2 permanent magnets 8a are placed on the back surface of the first optical axis deflecting member 4 (however, since their positions are invisible in FIG. 2, they are presented with dotted lines). A configuration is made such that coils not shown in the drawing are provided at positions separate from the permanent magnets 8a, so as to generate attractive force or repulsive force between the permanent magnets 8a and the coils by giving electric signals to the coil, to swing the first optical axis deflecting member 4 to the left and right around the axis by controlling the electric signals. Meanwhile, the mechanism to swing the first optical axis deflecting member 4 including the permanent magnets 8a and the coils not show in the drawing to swing the first optical axis deflecting member 4 around the axis is presented as a driving unit 8.

In addition, the second optical axis deflecting member 5 is a reflective member whose surface is an optical reflective surface (for example, an aluminum coated minor, a multilayer reflective mirror and the like), and 2 permanent magnets 9a are placed on the back surface of the first optical axis deflecting member 5. A configuration is made such that coils not shown in the drawing are provided at positions separate from the permanent magnets 9a, so as to generate attractive force or repulsive force between the permanent magnets 9a and the coils by giving electric signals to the coils, to swing the second optical axis deflecting member 5 to the left and right around the axis by controlling the electric signals, in the same manner as for the first optical axis deflecting member 4. Meanwhile, the mechanism to swing the first optical axis deflecting member 5 including the permanent magnets 9a and the coils not show in the drawing to swing the second optical axis deflecting member 5 around the axis is presented as a driving unit 9.

In addition, the driving unit 8 on the back surface of the first optical axis deflecting member 4 is connected to the optical axis shifting circuit 10 via a signal line, and the driving unit 9 on the back surface of the second optical axis deflecting member 5 is connected to the optical layout setting circuit 11 via a signal line. The optical axis shifting circuit 10 drives the driving unit 8 to swing the angle of the first optical axis deflecting member 4. Accordingly, without moving the image capturing apparatus 1 itself, the optical axis of the image capturing optical system 3 can be shifted between the first optical axis and the second optical axis. That is, the optical axis shifting circuit 10, the first optical axis deflecting member 4 and the driving unit 8 operate as an optical axis shifting mechanism.

In addition, the optical axis layout setting circuit 11 sets the degree of swing of the second optical axis deflecting member 5 with respect to the degree of swing of the first optical axis deflecting member 4, and drives the driving unit 9 to swing the second optical axis deflecting member 5 by the angle corresponding to the set degree of swing, in synchronization with the first optical axis deflecting member 4. Accordingly, the spatial layout of the first optical axis and the second optical axis are set. That is, the optical axis layout setting circuit 11, the second optical axis deflecting member 5 and the driving unit 9 operate as an optical axis layout setting mechanism.

Meanwhile, in the optical axis shifting mechanism and the optical axis layout setting mechanism described above, driving methods other than the coil may be adopted. For example, driving may be performed using piezoelements. In addition, It is also possible that 2 electrodes are placed with a predetermined distance and the polarities of the 2 electrodes are changed reciprocally to generate attractive force or repulsive force between the electrodes and to swing the first optical axis deflecting member 4 and the second optical axis deflecting member 5. Of course, a 2-dimensional micro mirror array such as DMD (Digital Micro-mirror Device) may be adopted to deflect the direction of the luminous flux in units of one micro-minor.

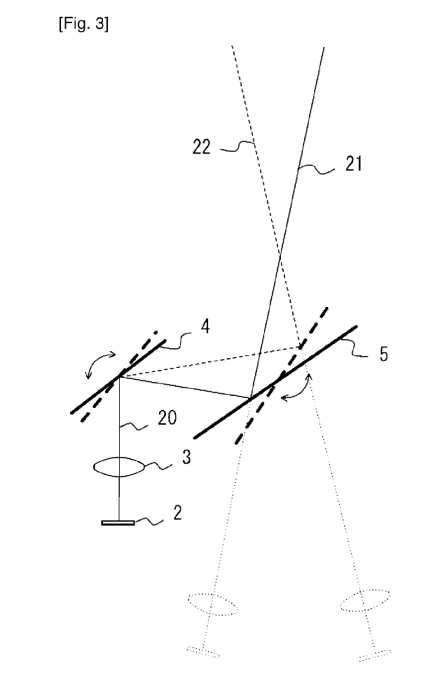

FIG. 3-FIG. 6 are diagrams illustrating the operations of the optical axis shifting mechanism and the optical layout setting mechanism described above. Meanwhile, for the sake of convenience, in view of the reversibility of the light beam travel, explanation is made assuming that the direction of the light axis extends from the image capturing element 2 to the subject. That is, the image capturing element 2, the image capturing optical system 3, the first optical axis deflecting member 4 and the second optical axis deflecting member 5 are arranged so that an optical axis 20 of the image capturing optical system 3 forwarding from the image capturing element 2 extends towards the subject not shown in the drawing through the first optical axis deflecting member 4 and the second optical axis deflecting member 5.

First, an operation to swing the angle of the first optical axis deflecting member 4 is performed by the optical axis shifting mechanism. That is, for the luminous flux of the optical axis 20, since the angle of the reflective surface of the first optical axis deflecting member 4 changes by the operation described above, the direction to which the luminous flux is reflected changes according to the angle change. As a result, the optical axis 20 shifts between a first optical axis 21 (solid line) and a second optical axis 22 (broken line).

Furthermore, an operation to swing the angle of the second optical axis deflecting member 5 in synchronization of the first optical axis deflecting member 4 at the same phase is performed by the optical axis layout setting mechanism. As a result, the directions of the first optical axis 21 and the second optical axis 22 are further changed. At this time, the degree of swing of the angle of the second optical axis deflecting member 5 with respect to the degree of swing of the angle of the first optical axis deflecting member 4 is set by the optical layout setting mechanism, and the characteristics of the 3-dimensional image can be selected by the setting.

In addition, the first optical axis 21 and the second optical axis are determined so that at least a part of the image capturing range with the first optical axis 21 and the image capturing range with the second optical axis 22 overlap. The first optical axis 21 and the second optical axis 22 are, so to speak, different optical axes, with at least one of their direction and position in the space being different, so the images of the subject in the overlapped part mentioned above captured with the first optical axis 21 and the second optical axis 22 have parallax with each other. Specifically, the optical axis layout setting mechanism is capable of setting, as needed, the layout of each optical axis in the space (at least one of the direction and position in the space of each optical axis), as illustrated in FIG. 3-FIG. 5.

FIG. 3 is the case in which the degree of swing of the angle of the second optical axis deflecting member 5 is larger than the degree of swing of the angle of the first optical axis deflecting member 4. In this case, the first optical axis 21 and the second optical axis 22 cross ahead of the image capturing apparatus 1 in the layout. While the dotted lines show the effective image capturing layout, this is the layout for the cross view method, so the image capturing apparatus 1 captures the 3-dimensional image of the subject by the cross view method, and a 3-dimensional image that is abound in stereoscopic effects can be obtained.

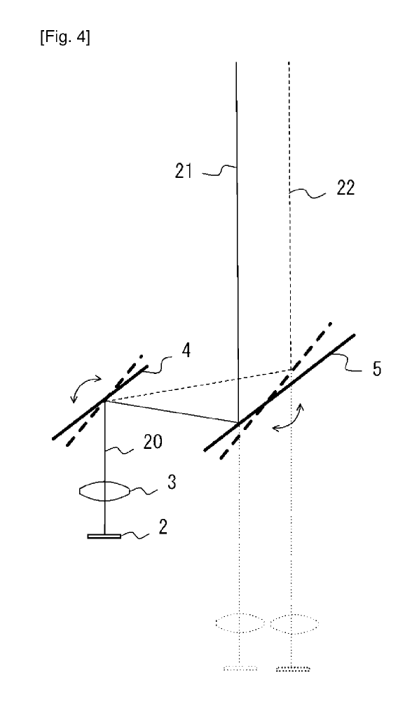

FIG. 4 is the case in which the degree of swing of the angle of the second optical axis deflecting member 5 is equal to the degree of swing of the angle of the first optical axis deflecting member 4. In this case, the first optical axis 21 and the second optical axis 22 are parallel in the layout. This is the layout for the parallel view method, so the image capturing apparatus 1 captures the 3-dimensional image of the subject by the parallel view method, making it possible to capture a 3-dimensional image with relatively less strain on eyes.

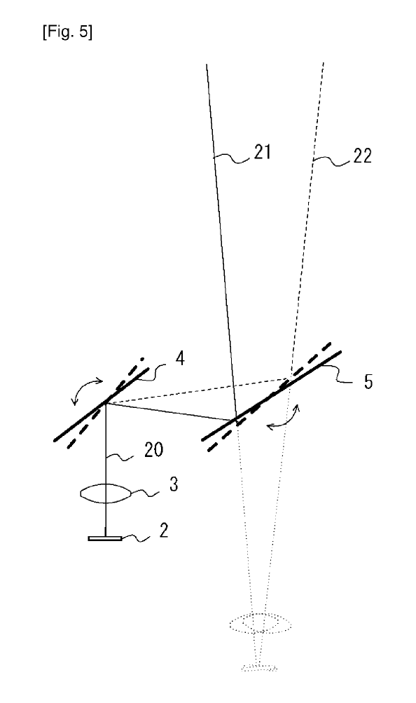

FIG. 5 is the case in which the degree of swing of the angle of the second optical axis deflecting member 5 is smaller than the degree of swing of the angle of the first optical axis deflecting member 4, with the layout of the first optical axis 21 and the second optical axis 22 being a V-shape. This layout makes it possible to capture a 3-dimensional image with further less strain on eyes.

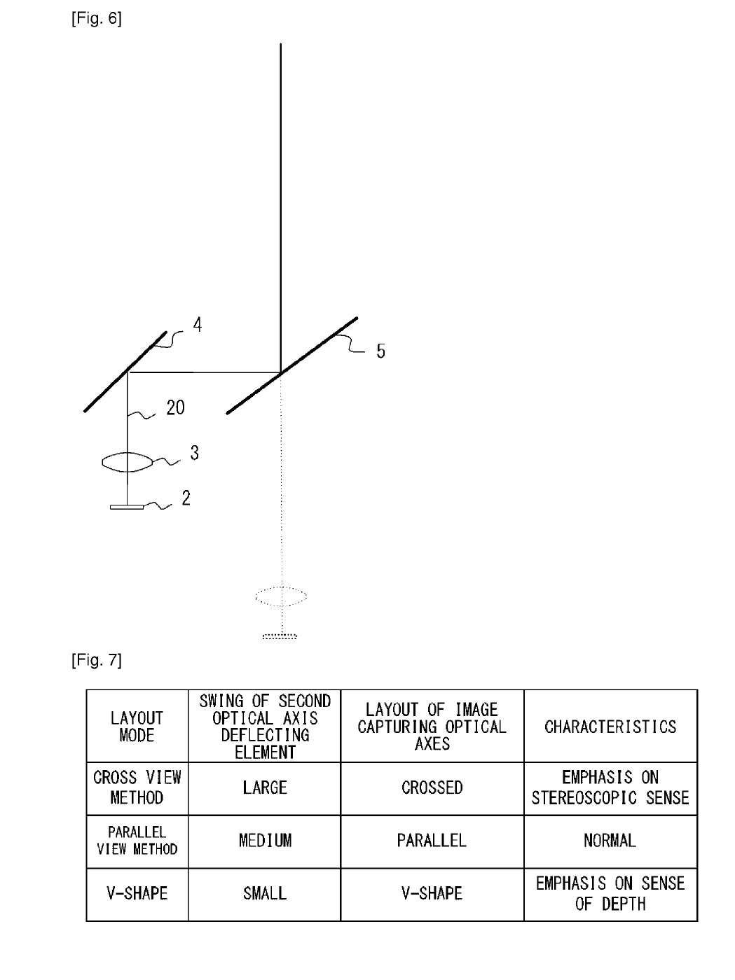

Meanwhile, FIG. 6 presents the case in which the angles of the first optical axis deflecting member 4 and the second optical axis deflecting member 5 do not swing. In this case, since the shift of the optical axes does not take place, the image capturing apparatus 1 captures a 2-dimensional image.

Thus, by making the first optical axis deflecting member 4 and the second optical axis deflecting member 5 vibrate in synchronization, 3-dimensional images having different properties can be captured with various optical axis layouts such as the cross view method, the parallel view method, the V-shape layout, or layouts being intermediate between them. Furthermore, by not making the first optical axis deflecting member 4 and the second optical axis deflecting member 5 vibrate, a 2-dimensional image can also be captured, making it possible to select a desired image capturing method from 2-dimensional image capturing and many types of 3-dimensional image capturing methods according to the situation and the subject. Meanwhile, FIG. 7 is a diagram compiling the characteristics and the like of the layout modes of the 3-dimensional image capturing described above.

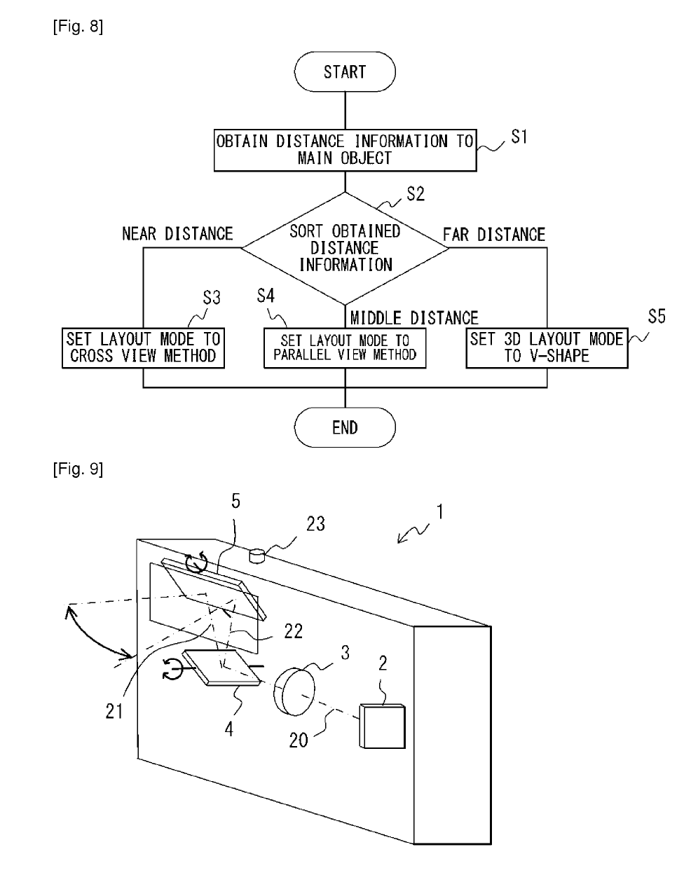

Here, the specific setting method of the layout modes described above is explained. FIG. 8 is a flowchart illustrating the setting method of the layout modes described above.

First, the image capturing apparatus 1 obtains distance information to the main subject (step (hereinafter, presented as S)1). In this obtaining of distance information, the distance to the main subject is obtained by the auto focus sensor 16 described above provided in the image capturing apparatus 1. Next, the obtained distance information is (S2). For example, the obtained distance information is categorized as near distance, medium distance and far distance, and the setting of the layout mode of the optical axes is performed according to the sorting result. Specifically, when the distance to the subject is less than 3 m for example, it is categorized as near distance, and the layout mode is set to the cross view method (S3). Meanwhile, when it is 3 m-10 m for example, it is categorized as middle distance, and the layout mode is set to the parallel view method (S4). Furthermore, when the distance to the subject is more than 10 m for example, it is categorized as far distance, and the layout mode is set to the V-shape (S5).

By processing as described above, the setting of the layout mode for 3-dimensional image capturing that is suitable for the distance to the subject can be performed automatically. Meanwhile, a desired layout mode for 3-dimensional image capturing can be selected by the user through a manual operation.

FIG. 9 presents the configuration of the image capturing apparatus 1 specifically laying out the image capturing element 2, the image capturing optical system 3, the first optical axis deflecting member 4 and the second optical axis deflecting member 5.

As illustrated in the figure, the image capturing element 2, the image capturing optical system 3, the first optical axis deflecting member 4 and the second optical axis deflecting member 5 are accommodated in the image capturing apparatus 1. The first changing member 4 is on the optical axis 20 of the image capturing optical system 3, and the second optical axis deflecting member 5 is disposed on the position where both the first optical axis 21 and the second optical axis 22 generated by the first changing member 4 by swinging the optical axis 20 go through. Meanwhile, in the example of the figure, in order to store the components compactly, the first optical axis deflecting member 4 and the second optical axis deflecting member 5 are disposed at the positions where the optical axis is twisted by 90 degrees. In addition, on the upper part of the image capturing apparatus 1, a release switch 23 is disposed.

FIG. 10 is a flowchart illustrating a process to capture a 3-dimensional image using the image capturing apparatus 1 configured as described above.

First, the power of the image capturing apparatus 1 is turned on (step (hereinafter, presented as ST)1). In the turning on of the power of the image capturing apparatus 1, by pressing down a power button that is not shown in the drawing, for example, power supply to the control circuit 18 and the like is performed.

After that, the image capturing apparatus 1 waits in a standby mode until the finger of an operator touches the release switch (release SW) 23 (ST2, NO in ST3). A touch sensor is embedded in the release SW 23 for example, and when the finger of the operator touches the release SW 23, the first optical axis deflecting member 4 and the second optical axis deflecting member 5 described above vibrate during the period in which the touch continues, and the optical axis keep shifting.

That is, when the finger of the operator touches the release SW 23 to capture an image of the subject (YES in ST3), then the setting of the 3-dimensional (3D) layout mode is performed (ST4), and the shift of the optical axes starts (ST5). There, the setting process of the 3-dimensional (3D) layout mode is the setting process of the layout mode explained in FIG. 8 described above, and the setting of the layout mode to the cross view method or the parallel view method or the V-shape is performed according to the distance to the subject.

Next, whether or not the release SW 23 has been turned on is determined (ST6). That is, from the state in which the finger of the operator touched the release SW23, whether or not the operator further pressed down the release SW 23 is determined. Here, if the operator presses down the release SW 23 (YES in ST6), whether the image capturing optical axis is the first optical axis or the second optical axis is determined (ST7). Meanwhile, in the case in which the operator does not further press down the release SW 23 from the state in which the finger of the operator touched the released SW 23 (NO in ST6), as long as the operator is keep touching the release SW 23 (YES in ST11), the waiting state for the pressing down of the release SW 23 is continued (loop between ST6 and ST11).

On the other hand, in the case in which the operator presses down the release SW 23 (YES in ST6), the image capturing circuit 13 captures either one of a left eye image and a right eye image at the timing when the optical axis of the image capturing optical system 3 becomes either one of the first optical axis 21 or the second optical axis 22 in shift between the first optical axis 21 and the second optical axis 22 (YES in ST7, ST8). For example, the image capturing circuit captures the left eye image at the timing when the optical axis of the image capturing optical system 3 becomes the first optical axis 21.

Next, at the timing when the optical axis of the image capturing optical system 3 becomes the other of the first optical axis 21 and the second optical axis 22, the other of the left eye image and the right eye image is captured (YES in ST9, ST10). As described above, if the left eye image was captured first at the timing when the optical axis of the image capturing optical system 3 was the first optical axis 21, then the right eye image is captured this time at the timing when the optical axis of the image capturing optical system 3 is being the second optical axis 22.

The process is continued as long as the released SW 23 is pressed down by the operator (YES in ST11). Therefore, in the above example, the left eye images are captured at the timing when the optical axis of the image capturing optical system 3 is being the first optical axis 21, and the right eye images are captured at the timing when the optical axis of the image capturing optical system 3 is being the second optical axis 22, capturing the left eye images and the right eye images at different timings by time divisional way.

Of course, the configuration may also be made so that the right eye image is captured at the timing when the optical axis of the image capturing optical system 3 is being the first optical axis 21 and the left eye image is captured at the timing when the optical axis of the image capturing optical system 3 is being the second optical axis 22.

The left eye image and the right eye image captured as described above are recorded sequentially in the recording medium 14 as one pair. Therefore, while the release SW 23 is pressed down by the operator, the image capturing data of the subject is recorded as a 3-dimensional image in the recording medium 14.

After that, when the operator removes the finger from the release SW (NO in ST11), the shift of the optical axes is terminated (ST12), and the shooting of the subject is terminated. Meanwhile, the image capturing process described above can be performed while the power of the image capturing apparatus 1 is on (NO in ST13), and the process is terminated by the power off (YES in ST13) of the image capturing apparatus 1.

Meanwhile, the above process is for the case of capturing moving images, where the first optical axis deflecting member 4 and the second optical axis deflecting member 5 vibrate at a high speed (for example, 60 times per second) continuously, and the frames for the left eye image and the frame for the right eye image are obtained in time series. On the other hand, in the case of capturing a still image, the shift of the first optical axis 21 and the second optical axis 22 finishes with only one time, and image data consisting of one piece of the left eye image and the right eye image is recorded in the recording medium 14.

Meanwhile, in the present embodiment, the shift of the image capturing axes by the 2 optical axis deflecting members 4, 5 presented in FIG. 3-FIG. 5 is done so that the first optical axis and the second optical axis are on a single plane, and parallax between the left eye image and the right eye image is generated in the direction along the plane. Then, the image capturing apparatus 1 is configured so that the first optical axis deflecting member 4 and the second optical axis deflecting member 5 vibrate so that when the image capturing apparatus is held horizontally, the plane (parallax direction) becomes horizontal and when held vertically, the plane (parallax direction) becomes vertical. Therefore, when the image capturing apparatus 1 is held horizontally, the separating direction (horizontally) of the left and right eyes of the photographer and the parallax (horizontally) between the left eye image and the right eye image match, and fusion of the images occurs normally at the time of the observation of the shot image, and a 3-dimensional image is recognized.

On the other hand, when the image capturing apparatus 1 is held vertically, the separating direction (horizontally) of the left and right eyes of the photographer and the parallax (vertically) between the left eye image and the right eye image do not match, and fusion of the images does not occur if the shot image is observed in the direction of the shooting time. In view of this point, the image capturing apparatus 1 is configured so that it detects the direction in which the image capturing apparatus 1 is held by the attitude sensor 15, and enables the 3D image capturing only when the image capturing apparatus 1 is held horizontally, and when the image capturing apparatus 2 is held vertically, only 2D image capturing can be performed.

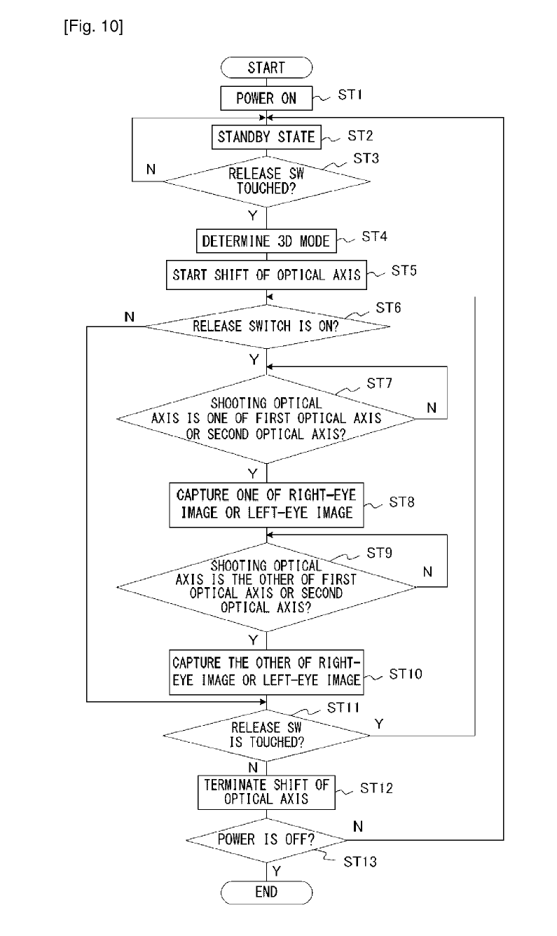

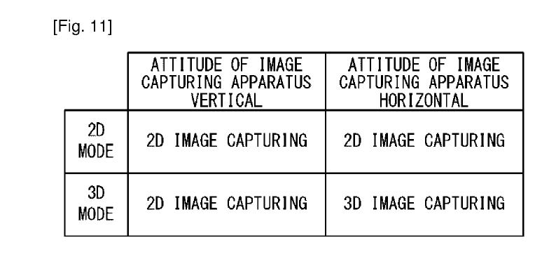

Specifically, as presented in FIG. 11, the operator can choose the image capturing mode from the “2D mode” and “3D mode” in the image capturing apparatus 1. When the operator chooses the “2D mode”, 2D shooting is performed regardless of the direction in which the image capturing apparatus 1 is held. That is, as presented in FIG. 6, 2D shooting is performed without swinging the angles of the first optical axis deflecting member 4 and the second optical axis deflecting member 5.

On the other hand, when the operator chooses the “3D mode”, the image capturing apparatus 1 performs 3D image capturing only when the image capturing apparatus 1 is held horizontally according to the attitude sensor 15, and when the image capturing apparatus 1 is held vertically, performs 2D image capturing. When the 2D image capturing is performed, since the image capturing is performed in a different mode to the specified image capturing mode, a warning is displayed on the display unit 17.

FIG. 12 is a variation example of the first embodiment, illustrating an example of an image capturing apparatus 24 configured to be able to capture a 3-dimensional image both when held vertically and when held horizontally.

In the image capturing apparatus 24, the configuration of the image capturing element 2, the image capturing optical system 3, the first optical axis deflecting member 4, the second optical axis deflecting member 5, the optical axis shifting circuit 10, the optical axis layout setting circuit 11, the image capturing optical system driving unit 12, the image capturing circuit 13, the recording medium 14, the attitude sensor 15, the auto focus sensor 16, the display unit 17 and the control circuit 18 is the same as in the image capturing apparatus 1 described above. The difference over the image capturing apparatus resides that the configuration of a first optical axis deflecting member 24 and the second optical axis deflecting member 26 is different from that of the first optical axis deflecting member 4 and the second optical axis deflecting member 5, in being able to be swung to 2 directions.

Specifically, the first optical axis deflecting member 25 and the second optical axis deflecting member 26 are made as a reflective member that vibrates with 2 axes (for example, a gimbal mirror). Other than that, a reflective member that can be swung to 2 directions can be configured using a pillar-support type minor that is supported at one point. Explaining the configuration of the second optical axis deflecting member 26 in FIG. 12, an axis 27 is disposed in the horizontal direction of the second optical axis deflecting member 26, and an axis 28 is disposed in the vertical direction. In addition, driving units 27a, 27b for swinging the second optical axis deflecting member 26 around the axis 27 are disposed, and driving units 28a, 28b for swinging the second optical axis deflecting member 26 around the axis 28 are disposed. Meanwhile, while not specifically described in FIG. 12, the configuration is the same for the first optical axis deflecting member 25.

By the configuration described above, when the image capturing apparatus 24 is held horizontally, a normal parallax image can be obtained by swinging the first optical axis deflecting member 25 and the second optical axis deflecting member 26 respectively in the horizontal direction. Meanwhile, when the image capturing apparatus 24 is held vertically, a normal parallax image can be obtained by swinging the first optical axis deflecting member 25 and the second optical axis deflecting member 26 respectively in the vertical direction. Therefore, by selecting and using the driving units according to the direction in which the image capturing apparatus 24 is held, it becomes possible to capture a 3-dimensional image both when the image capturing apparatus 24 is held vertically or horizontally.

As presented in FIG. 13, in the image capturing apparatus 24, when the operator selects the “2D mode”, 2D shooting is performed regardless of the direction in which the image capturing apparatus 24 is held, and when the “3D mode” is selected, 3D shooting is performed regardless of the direction in which the image capturing apparatus 24 is held.

### Second Embodiment

Next, the second embodiment of the present invention is explained.

FIG. 14 is a diagram presenting the configuration of an image capturing apparatus 30 of the second embodiment of the present invention. In the figure, the image capturing apparatus 30 is constituted by, in the same manner as in the first embodiment described above, an image capturing element 2, an image capturing optical system 3, a first optical axis deflecting member 31, a second optical axis deflecting member 32, an optical axis shifting circuit 10, an optical axis layout setting circuit 11, an image capturing optical system driving unit 12, an image capturing circuit 13, a recording medium 14, a attitude sensor 15, an auto focus sensor 16, a display unit 17, and a control circuit 18. Here, the configuration of the second optical axis deflecting member 32 is the same as that of the optical axis deflecting member 5 described above, but the configuration of the first optical axis deflecting member 31 is different from that of the first optical axis deflecting member 4.

The first optical axis deflecting member 31 is cylindrical one, being an image capturing unit including the image capturing element 2 and the image capturing optical system 3. The cylindrical first optical axis deflecting member 31 can be shifted to the direction of the arrow a. The driving units 31a, 31b are driven according to the control signal output from the optical axis shifting circuit 10, to shift the first optical axis deflecting member 31 in the direction of the arrow a. Therefore, in the second embodiment, the image capturing optical system itself is swung instead of a reflective member.

Meanwhile, the driving of the second optical axis deflecting member is the same as in the first embodiment, where a driving unit 32a is driven according to a driving signal output from the optical axis layout setting circuit 11, and the second optical axis deflecting member 32 is shifted to the direction of the arrow b around the axis 32b.

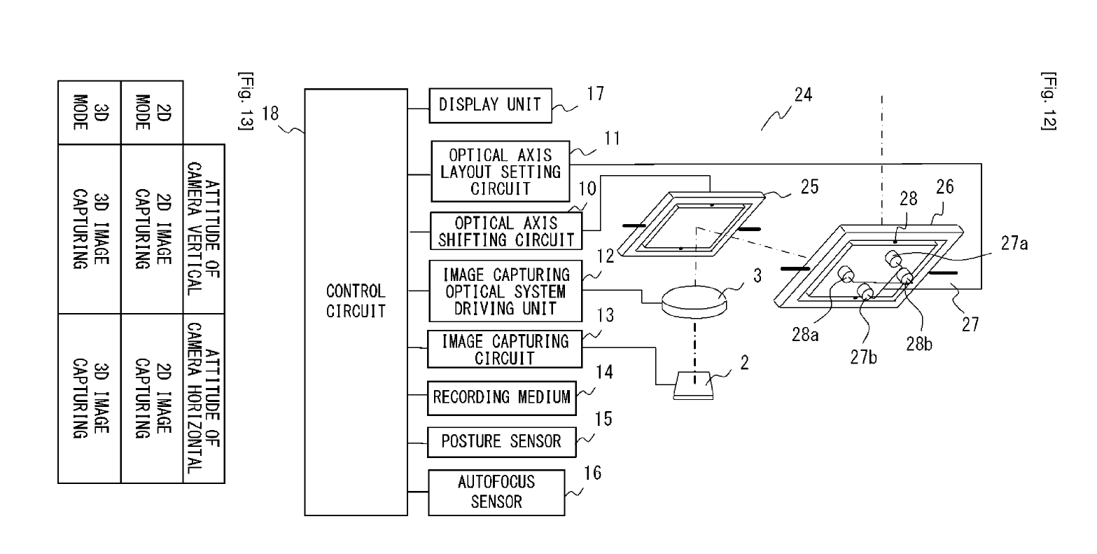

FIG. 15A presents the configuration of an image capturing apparatus 30 specifically laying out the first optical axis deflecting member 31 accommodating the image capturing element 2 and the image capturing optical system 3, and the second optical axis deflecting member 32. Meanwhile, in the same manner as in the first embodiment, the release switch 23 is disposed on the upper part of the image capturing apparatus 30.

In this embodiment, the image capturing unit (first optical axis deflecting member) 31 is swung to the direction of the arrow a by a driving signal output from the optical axis shifting circuit 10, to directly form the first image capturing optical axis 21 and the second image capturing optical axis 22. Furthermore, the special layout of the first image capturing optical axis 21 and the second image capturing optical axis 22 is set by the second optical axis deflecting member 32 controlled by the optical layout setting circuit 11.

Meanwhile, while FIG. 15B is the similar configuration as FIG. 15A, in the image capturing apparatus 30, a rotation axis 32b of the second optical axis deflecting member 32 is disposed in the vertical direction in FIG. 15B, whereas in the image capturing apparatus 30 in FIG. 15A, a rotation axis 32a of the second optical axis deflecting member 32 is disposed to have a tilt with respect to the vertical direction.

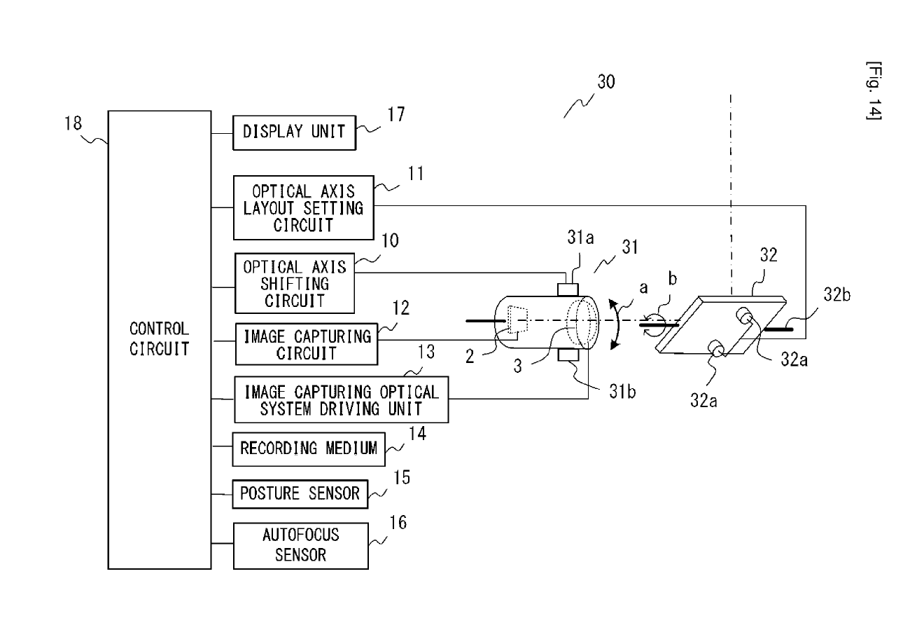

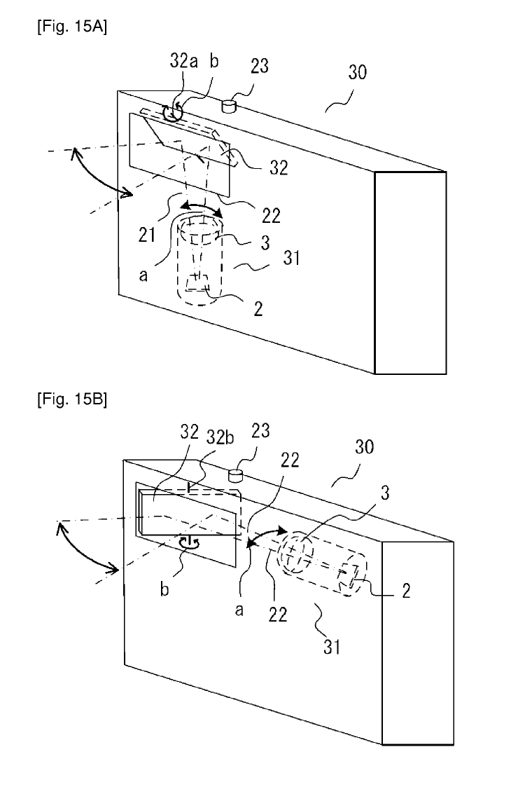

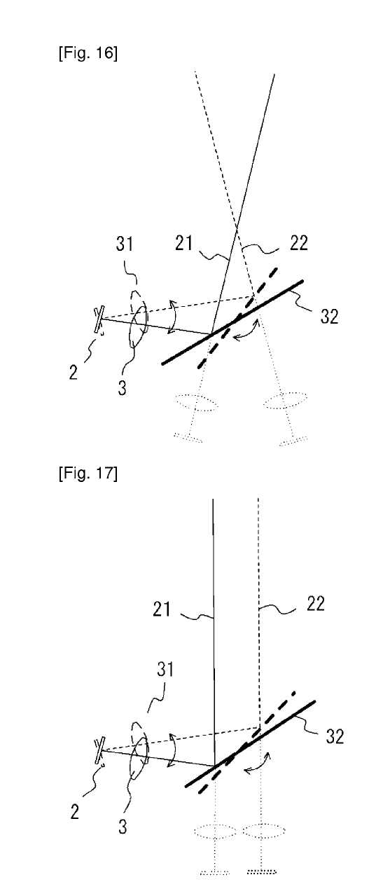

FIG. 16-FIG. 19 are diagrams illustrating the layout modes set by the image capturing apparatus 30 of the second embodiment.

FIG. 16 is the case in which the degree of swing of the angle of the second optical axis deflecting member 32 is larger than the degree of swing of the angle of the first optical axis deflecting member 31. In this case, the first optical axis 21 and the second optical axis 22 cross ahead of the image capturing apparatus 30 in the layout, so the image capturing apparatus 30 captures the 3-dimensional image of the subject by the cross view method, and a 3-dimensional image that is abound in stereoscopic effects can be obtained.

Meanwhile, FIG. 17 is the case in which the degree of swing of the angle of the second optical axis deflecting member 32 is smaller than the degree of swing of the angle of the first optical axis deflecting member 31, with the layout of the first optical axis 21 and the second optical axis 22 being parallel, and the image capturing apparatus 30 captures a 3-dimensional image of the subject by the parallel view method. In this case, as described above, a 3-dimensional image with relatively less strain on eyes can be captured.

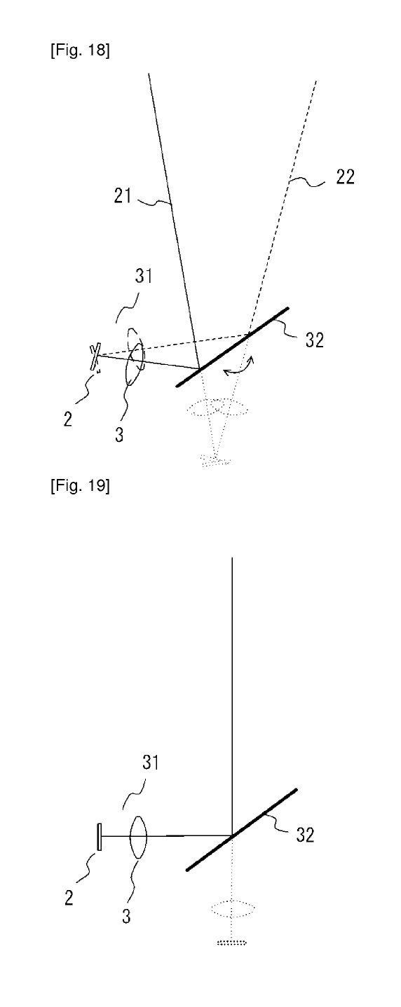

Furthermore, FIG. 18 is the case in which the angle of the second optical axis deflecting member 32 does not swing. In this case, the layout of the first optical axis 21 and the second optical axis 22 becomes V-shape, and a 3-dimensional image with further less strain on eyes can be captured.

Meanwhile, FIG. 19 is the case in which the angles of the first optical axis deflecting member 31 and the second optical axis deflecting member 32 do not swing, where the shift of the optical axes does not take place and the image capturing apparatus 1 captures a 2-dimensional image.

### Third Embodiment

Next, the third embodiment of the present invention is explained.

FIG. 20 is a diagram presenting the configuration of an image capturing apparatus 33 of the third embodiment of the present invention. In the figure, the image capturing apparatus 33 has, in the same manner as in the first and second embodiments described above, an image capturing element 2, an image capturing optical system 3, a first optical axis deflecting member 34, a second optical axis deflecting member 35, an optical axis shifting circuit 10, an optical axis layout setting circuit 11, an image capturing optical system driving unit 12, an image capturing circuit 13, a recording medium 14, a attitude sensor 15, an auto focus sensor 16, a display unit 17, and a control circuit 18, and further has a rotation unit 36. A first optical axis deflecting member 34 and a second optical axis deflecting member 35 are disposed in the rotation unit 36. That is, in the present embodiment, the first optical axis deflecting member 34 and a second optical axis deflecting member 35 are accommodated in the rotation unit 36, and the rotation unit 36 is configured to be rotatable by a motor 34a.

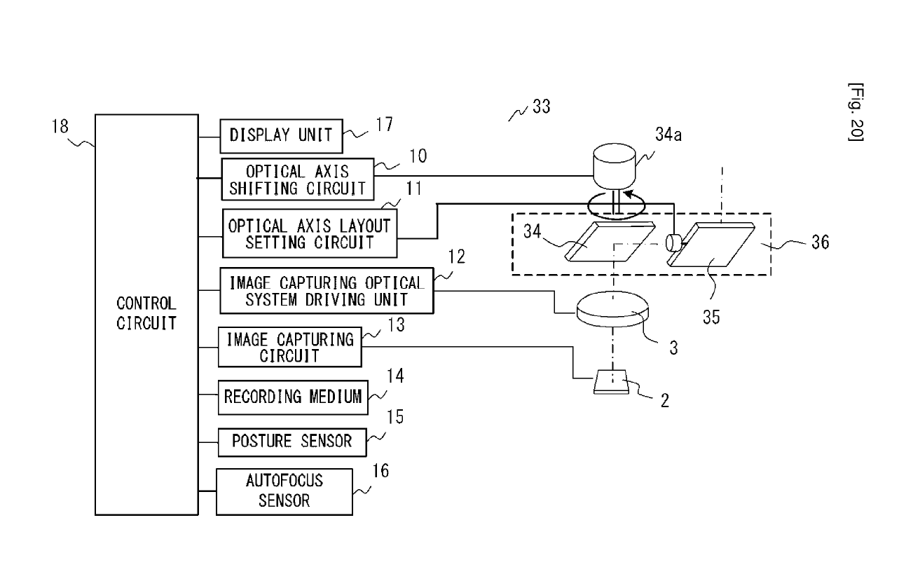

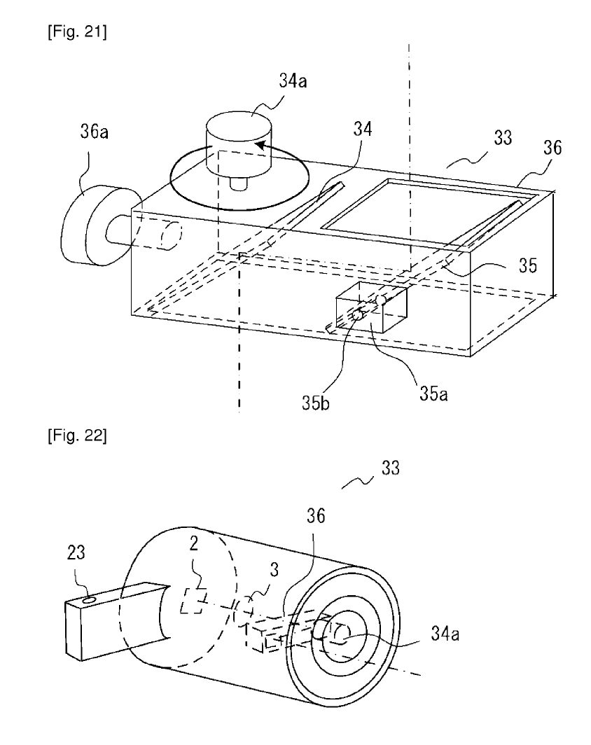

FIG. 21 is a schematic diagram of the rotation unit 36 mentioned above. The first optical axis deflecting member 34 and a second optical axis deflecting member 35 are a reflective member whose surface is an optical reflective surface (for example, an aluminum coated mirror, a multilayer reflective minor and the like). The optical axis of the image capturing optical system 3 is bent by the first optical axis deflecting member 34, and further bent by the second optical axis deflecting member 35, to reach the subject (not shown in the drawing). In addition, the optical axis of the image capturing optical system 3 is coaxial with the rotation axis of the rotation unit 36.

The motor 34a makes the rotation unit 36 rotate around the optical axis of the image capturing optical system. Then, the exit position of the optical axis directed to the subject from the rotation unit 36 also moves, drawing a circular trajectory. In the movement of the exit position of the optical axis, by performing image capturing when the exit position of the optical axis comes to 2 different positions on the circumference respectively, the optical axis of the image capturing optical system is shifted between the first optical axis and the second optical axis. That is, the optical axes corresponds to the 2 times of image capturing become the first optical axis and the second optical axis. Thus, the rotation unit 36 that is rotated by the motor 34a and the image capturing circuit 13 that directs image capturing at different timings during the rotation of the rotation unit 36 function as the optical axis shifting mechanism.

Meanwhile, a counter weight 36a is disposed in the rotation unit 36, so that the center of gravity of the rotation unit 36 is positioned on the rotation axis of the motor 34a, so that the rotation unit 36 rotates smoothly.

FIG. 22 is a specific configuration example of the image capturing unit 33, where the first optical axis deflection member 34 and the second optical axis deflection member 35 are accommodated in the rotation unit 36, and the rotation unit 36 is configured to be rotatable by the driving of the motor 34a.

Here, the tilt of the second optical axis deflecting member 35 is changeable, and the tilt of the second optical axis deflecting member 35 changes around the axis 35b, by driving the driving unit 35a by the optical axis layout setting circuit 11, the spatial layout of the first and second optical axes changes. Therefore, the optical axis layout setting circuit 11, the second optical axis deflecting member 35, and the driving unit 35a function as the optical axis layout setting mechanism for setting the spatial layout of the first and second optical axes.

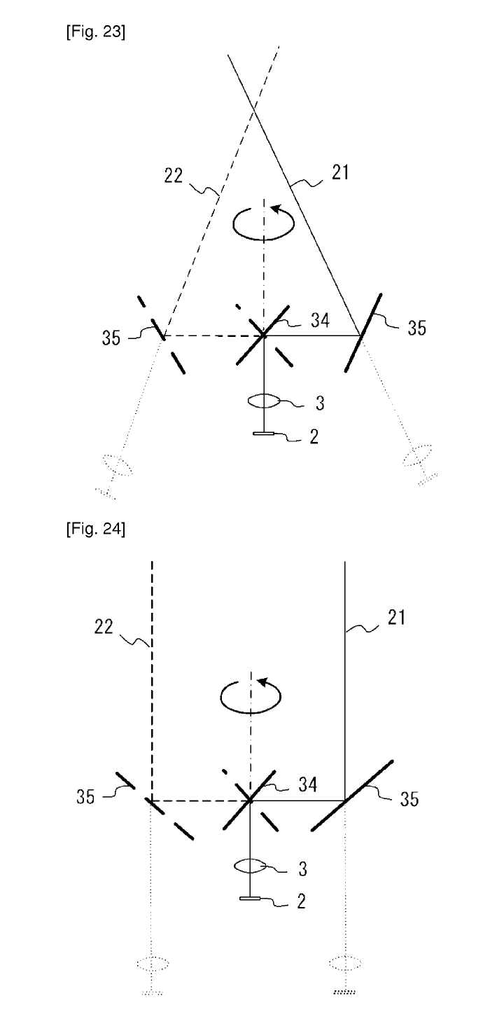

FIG. 23-FIG. 25 are diagrams illustrating the layout modes of the optical axes set by the image capturing apparatus 33 of the third embodiment.

First, FIG. 23 is the case in which the angle of the tilt of the second optical deflecting member 35 with respect to the incident optical axis is larger than the angle of the tilt of the first optical deflecting member 34 with respect to the incident optical axis. In this case, the first optical axis 21 and the second optical axis 22 cross ahead of the image capturing apparatus 30 in the layout, so the image capturing apparatus 33 captures the 3-dimensional image of the subject by the cross view method, and a 3-dimensional image that is abound in stereoscopic effects can be obtained.

Meanwhile, FIG. 24 is the case in which the angle of the tilt of the second optical deflecting member 35 with respect to the incident optical axis is equal to the angle of the tilt of the first optical deflecting member 34 with respect to the incident optical axis. In this case, the first optical axis 21 and the second optical axis 22 are parallel in the layout, so the image capturing apparatus 33 captures the 3-dimensional image of the subject by the parallel view method, making it possible to capture a 3-dimensional image with relatively less strain on eyes.

Furthermore, FIG. 25 is the case in which the angle of the tilt of the second optical deflecting member 35 with respect to the incident optical axis is smaller than the angle of the tilt of the first optical deflecting member 34 with respect to the incident optical axis, where the layout of the first optical axis 21 and the second optical axis 22 becomes the V-shape. In this case, a 3-dimensional image with further less strain on eyes can be obtained.

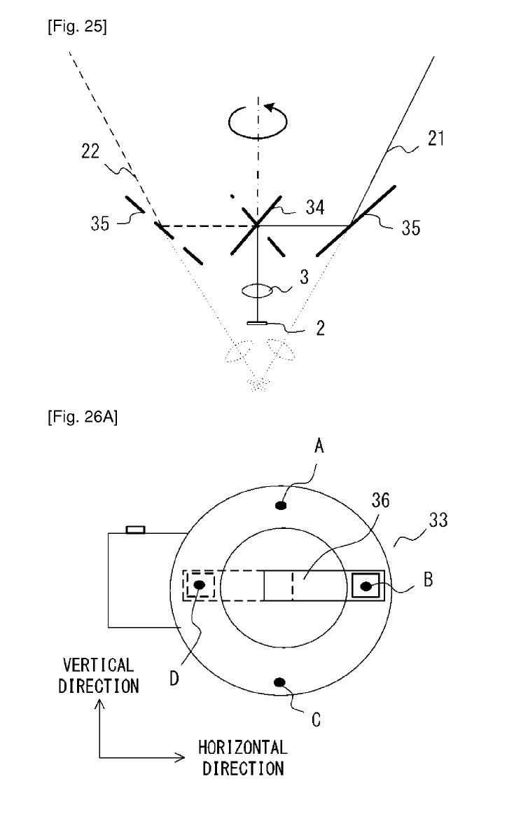

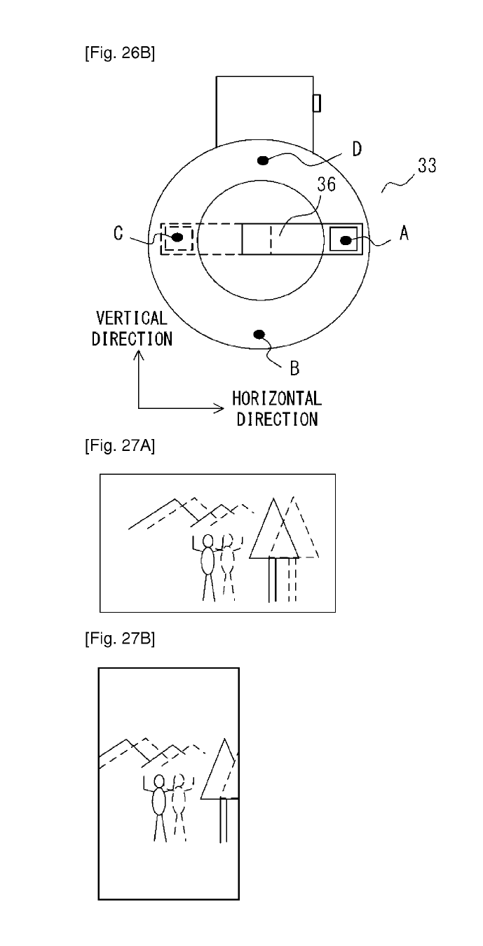

FIGS. 26A, 26B and FIGS. 27A, 27B are illustration diagrams, illustrating that the timing of image capturing is changed according to the direction in which the operator holds the image capturing apparatus 33, thereby matching the direction of the separation between the left and right eyes of the operator and the parallax direction of the captured left eye image and the right eye image.

First, FIG. 26A is an example in which the image capturing apparatus 33 is held horizontally, where the image capturing circuit 13 performs image capturing at the timing when the rotation unit 36 comes to the positions B and D locating horizontally with respect to the rotation axis. For example, it is determined that the optical axis becomes the first optical axis at the timing when the rotation unit 36 comes to the position B, and one of the left eye image and the right eye image is captured. Furthermore, it is determined that the optical axis becomes the second optical axis at the timing when the rotation unit 36 comes to the position D, and the other of the left eye image and the right eye image is captured. Accordingly, as illustrated in FIG. 27A, a 3D-image whose parallax (gap of images) is horizontal is acquired. Therefore, when viewing the image in the same direction as the composition at the time of the image capturing, the direction of parallax matches, enabling fusion of the images and observation as a 3-dimensional image.

On the other hand, FIG. 26B is an example in which the image capturing apparatus 33 is held vertically, where the image capturing circuit 13 performs image capturing at the timing when the rotation unit 36 comes to the positions A and C locating horizontally with respect to the rotation axis. For example, it is determined that the optical axis becomes the first optical axis at the timing when the rotation unit 36 comes to the position A, and one of the left eye image and the right eye image is captured. Furthermore, it is determined that the optical axis becomes the second optical axis at the timing when the rotation unit 36 comes to the position C, and the other of the left eye image and the right eye image is captured. Accordingly, as illustrated in FIG. 27B, a 3-dimensional image in which the direction of the parallax becomes horizontal when viewing the image in the same direction as the composition at the timing of image capturing is acquired (the same direction as the direction of the separation between the left and right eyes of the operator at the time of shooting), enabling fusion of the images.

### Fourth Embodiment

Next, the fourth embodiment of the present invention is explained.

FIG. 28 is a diagram presenting the configuration of an image capturing apparatus 40 of the fourth embodiment of the present invention. In the figure, the image capturing apparatus 40 has an optical axis shifting circuit 10, the optical layout setting circuit 11, the image capturing optical system driving unit 12, the image capturing circuit 13, the recording medium 14, the attitude sensor 15, the auto focus sensor 16, the display unit 17 and the control circuit 18, and further has a rotation unit 43. The rotation unit 43 is rotatable by the motor 44, and a cylindrical body 46 is attached to the rotation unit 43 in a manner that the tilt of the cylindrical body 46 can be changed in a radial direction of the rotation axis. The image capturing element 2 and the image capturing optical system 3 are accommodated inside the cylindrical body 46, so the cylindrical body is an image capturing unit.

In the image capturing apparatus 40 of the present embodiment, in the same manner as in the image capturing apparatus 33 of the third embodiment, by making the rotation unit 43 rotate by the motor 44, the exit position of the optical axis from the cylindrical body 46, or the image capturing unit, mounted to the rotation unit 43 moves on a circumference. In the movement of the exit position of the optical axis, by performing image capturing when the exit position of the optical axis comes to 2 different positions on the circumference respectively, the optical axis of the image capturing optical system is shifted between the first optical axis and the second optical axis. That is, the optical axes at the 2 times of image capturing become the first optical axis and the second optical axis. Thus, the rotation unit 43 that is rotated by the motor 44 and the image capturing circuit 13 that directs image capturing at different timings during the rotation of the rotation unit 43 function as the optical axis shifting mechanism.

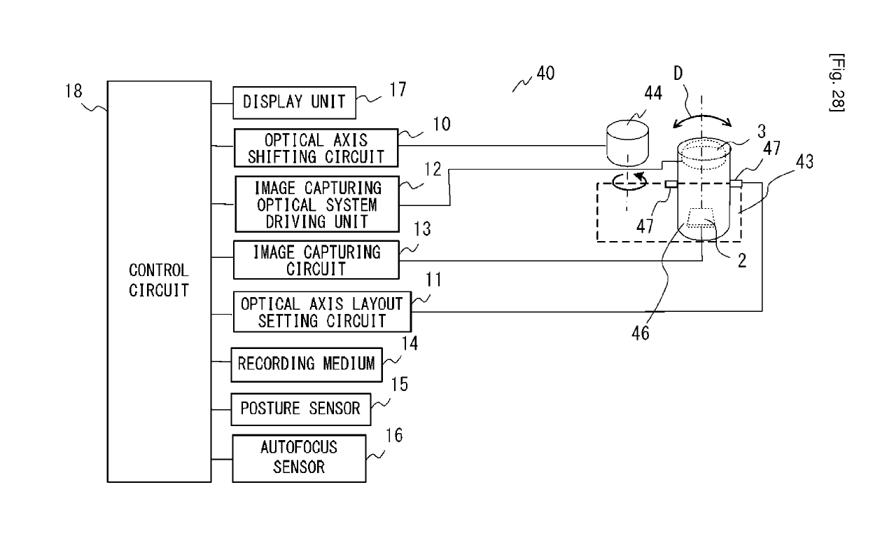

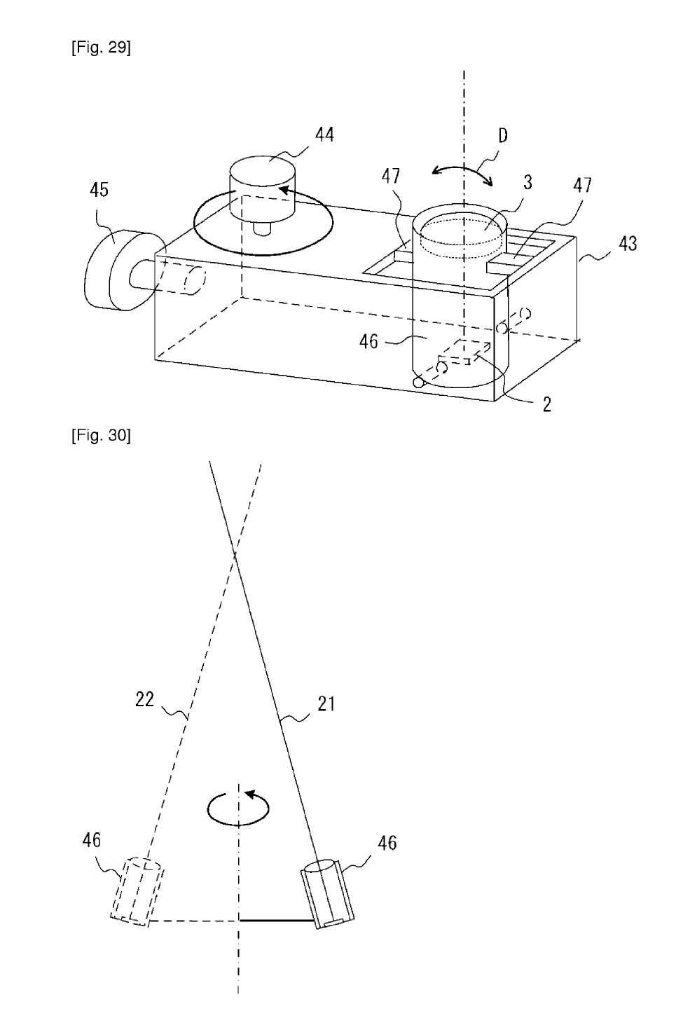

FIG. 29 is a schematic diagram of the rotation unit 43, where, in the same manner as in the image capturing apparatus 33 described above, a counter weight 45 is provided on the rotation unit 43 to adjust the position of the center of gravity. The tilt of the cylindrical body 46, or the image capturing unit, can be shifted in the direction of the arrow D by a driving unit 47 which is an actuator (for example, a piezoelement) according to the direction from the optical axis layout setting circuit 11. That is, the optical axis layout setting circuit 11 and the driving unit 47 set the tilt of the image capturing optical system itself, and function as the optical axis layout setting mechanism for setting the special layout of the first and second optical axes.

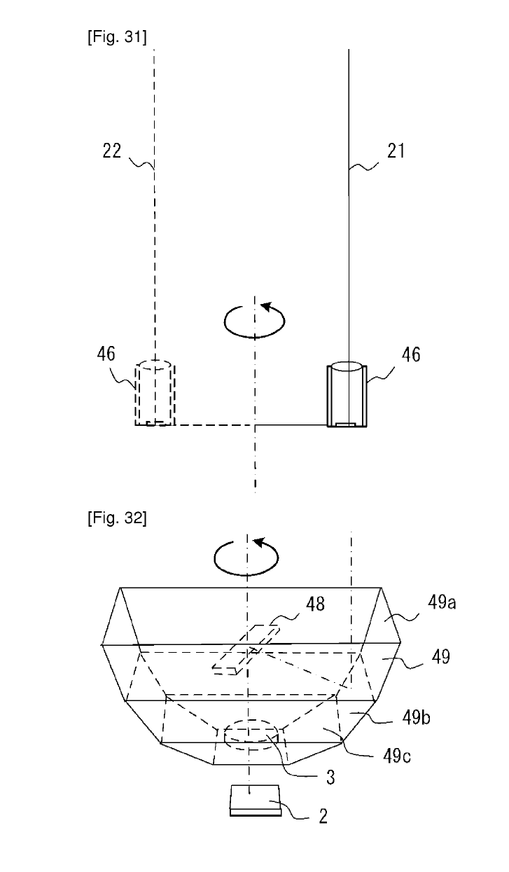

FIG. 30 and FIG. 31 are diagrams illustrating the layout modes set by the image capturing apparatus 40 of the present embodiment, and for example. As presented in FIG. 30, by tilting the cylindrical body 46 inward, the first optical axis 21 and the second optical axis 22 cross ahead of the image capturing apparatus 40 as the layout of the cross view method. Therefore, the image capturing apparatus 40 captures a 3-dimensional image of the subject by the cross view method, and a 3-dimensional image that is abound in stereoscopic effects can be obtained.

On the other hand, as presented in FIG. 31, by holding the cylindrical body 46 on the position parallel to the rotation axis, the first optical axis 21 and the second optical axis 22 become parallel as the layout of the parallel view method. Therefore, the image capturing apparatus 40 captures an 3-dimensional image of the subject by the parallel view method, making it possible to capture a 3-dimensional image with relatively less strain on eyes.

In addition, while not shown in the drawing, setting of the first optical axis 21 and the second optical axis 22 to the V-shape layout can be performed by turning the cylindrical body 46 outward.

In addition, in the same manner as in the third embodiment, by changing the 2 image capturing timings according to the attitude of the image capturing apparatus 40, the parallax direction can be matched when observing the captured image in the direction at the time of image capturing.

Meanwhile, the position of the image capturing unit is moved by rotational movement in the present embodiment. However, translational movement can be adopted, and configuration may be made so that the image capturing unit performs reciprocal movement on a straight route or a curved route, and shooting corresponding to the first optical axis and shooting corresponding to the second optical axis are performed at desired timings during the movement.

### Fifth Embodiment

Next, the fifth embodiment of the present invention is explained.

FIG. 32 is a diagram illustrating the fifth embodiment of the present invention. While the configuration of the entirety of the image capturing apparatus is not presented, the configuration of the image capturing element 2, the image capturing optical system 3, the optical axis shifting circuit 10, the optical axis layout setting circuit 11 and the like is the same as in each embodiment described above.

In the present embodiment, a first optical axis deflecting member 48, which is a reflective member whose surface is an optical reflective surface, is disposed on the optical axis of the image capturing optical system 3 to be rotatable coaxially with the optical axis. In addition, a second optical axis deflecting member 49 is disposed to surround the circumference of the first optical axis deflecting member 48, in a shape having a plurality of reflective surfaces having different tilts inside. In the present embodiment, the reflective surfaces of the second optical axis deflecting member 49 are constituted with a first reflective surface 49a with a large angle, a second reflective surface 49b with a smaller angle than that for the first reflective surface 49a, and a third reflective surface 49c with a further smaller angle than that of the second reflective surface 49b.

The optical axis of the image capturing optical system is bent towards the second optical axis deflecting member by the first optical axis deflecting member 48, and further bent by the second optical axis deflecting member 49, to be directed to the subject. At this time, by the rotational movement of the first optical axis deflecting member 48, the intersection point of the optical axis on the second optical axis deflecting member 49 moves drawing a closed path on the inner surface of the second optical axis deflecting member 49. In this movement of the intersection of the optical axis, by performing image capturing when the intersection comes to 2 different positions respectively, the optical axis of the image capturing optical system is shifted between the first optical axis and the second optical axis. That is, the optical axes at the 2 times of image capturing become the first optical axis and the second optical axis.

Thus, the rotating first optical axis deflecting member 48 and the image capturing circuit 13 that directs image capturing at different timings during the rotation of the first optical axis deflecting member 48 function as the optical axis shifting mechanism. The image capturing apparatus of the present embodiment sets the spatial layout of the optical axes by selecting the reflective surfaces 49a-49c to be positioned in the optical path of the image capturing optical system from the second optical axis deflecting member 49 having a plurality of reflective surfaces by adjusting the orientation of the first optical axis deflecting member 48 by the direction from the optical axis layout setting circuit 11. Therefore, the optical axis layout setting circuit 11, the first optical axis deflecting member 48 and the second optical axis deflecting member 49 function as the optical axis layout setting mechanism.

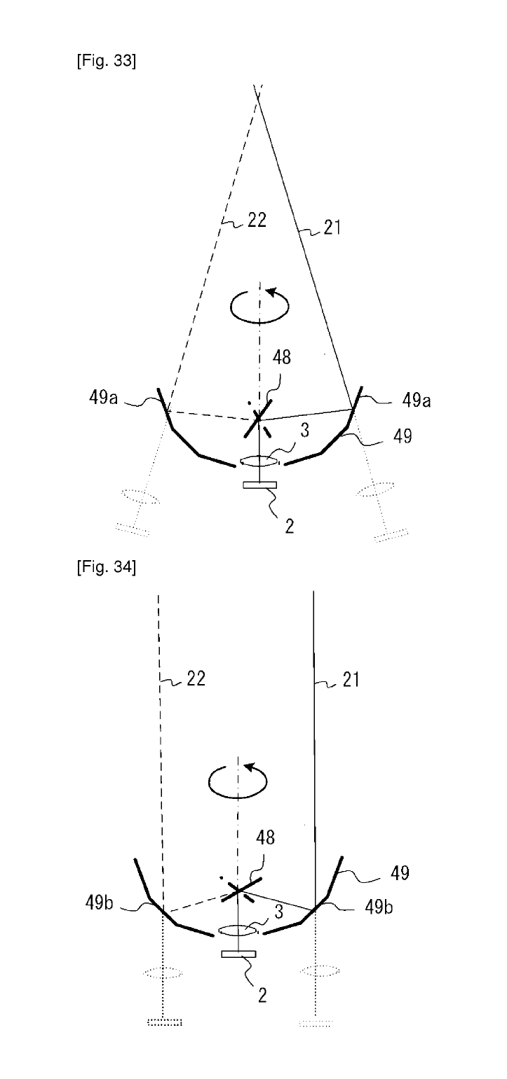

For example, in FIG. 33, the orientation of the first optical axis deflecting member 48 is adjusted, to form the first and second optical axes 21, 22 reflected on the first reflective surface 49a of the second optical axis deflecting member 49, and the first optical axis 21 and the second optical axis 22 are crossed ahead of the image capturing apparatus. Accordingly, the image capturing apparatus captures a 3-dimensional image of the subject by the cross view method, and a 3-dimensional image that is abound in stereoscopic effects is obtained.

Meanwhile, in FIG. 34, in the same manner, the orientation of the first optical axis deflecting member 48 is adjusted, to form the first and second optical axes 21, 22 reflected on the second reflective surface 49b of the second optical axis deflecting member 49, forming the layout in which the first optical axis 21 and the second optical axis 22 are parallel. Accordingly, the image capturing apparatus captures a 3-dimensional image of the subject by the parallel view method, and a 3-dimensional image with relatively less strain on eyes is obtained.

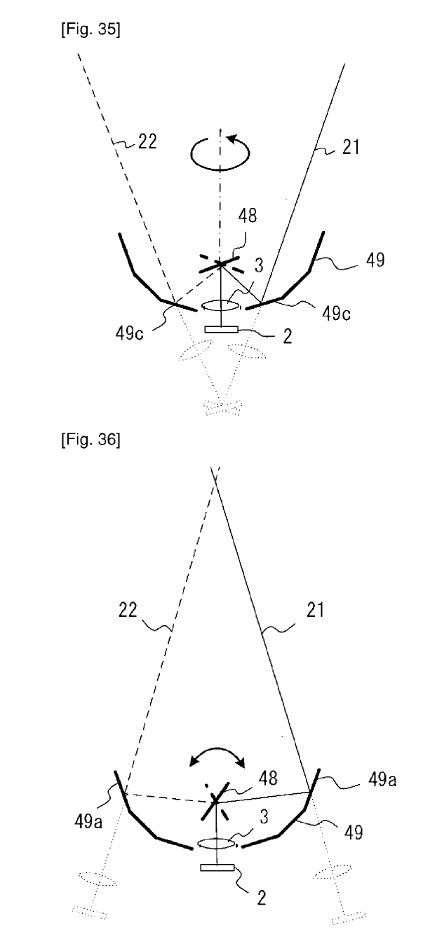

Furthermore, in the same manner, in FIG. 35, the orientation of the first optical axis deflecting member 48 is adjusted, to form the first and second optical axes 21, 22 reflected on the second reflective surface 49c of the second optical axis deflecting member 49, forming the layout in which the first optical axis 21 and the second optical axis 22 are in the V-shape. Accordingly, the image capturing apparatus captures a 3-dimensional image of the subject in the state in which the first optical axis 21 and the second optical axis 22 are in the V-shape layout, and a 3-dimensional image with further less strain on eyes is obtained.

Meanwhile, FIG. 36-FIG. 38 are variation examples of the fifth embodiment described above, where the first optical axis deflecting member 48 is swung to the left and right instead of being rotated around the optical axis. This configuration also makes it possible to perform setting of various layouts.

For example, in the case of FIG. 36, the orientation of the first optical axis deflecting member 48 is adjusted, to form the first and second optical axes 21, 22 reflected on the first reflective surface 49a of the second optical axis deflecting member 49, and the first optical axis 21 and the second optical axis 22 are crossed ahead of the image capturing apparatus. Accordingly, a 3-dimensional image of the subject can be captured by the cross view method.

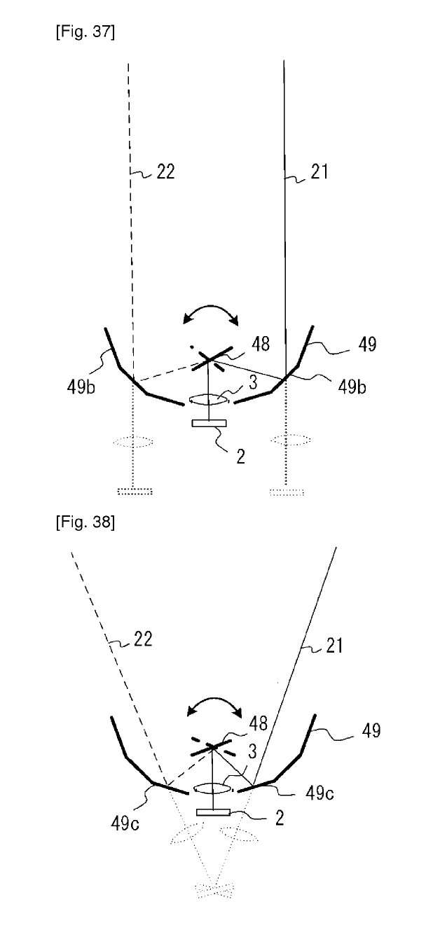

In addition, in the case of FIG. 37, the orientation of the first optical axis deflecting member 48 is adjusted, to form the first and second optical axes 21, 22 reflected on the second reflective surface 49b of the second optical axis deflecting member 49, forming the layout in which the first optical axis 21 and the second optical axis 22 are parallel. Accordingly, a 3-dimensional image of the subject can be captured by the parallel view method.

Furthermore, in the case of FIG. 38, in the same manner, the orientation of the first optical axis deflecting member 48 is adjusted, to form the first and second optical axes 21, 22 reflected on the second reflective surface 49c of the second optical axis deflecting member 49, forming the layout in which the first optical axis 21 and the second optical axis 22 are in the V-shape. Accordingly, a 3-dimensional image of the subject can be captured in the state in which the first optical axis 21 and the second optical axis 22 are in the V-shape layout.

### Sixth Embodiment

Next, the sixth embodiment of the present invention is explained.

The sixth embodiment shifts the first optical axis and the second optical axis using a polarization phenomenon.

In the present embodiment, a polarization switching element (for example, a combination of a polarization plate and liquid crystal, a combination of a polarization plate and a Faraday rotator, and the like) that switches the polarization property of incident light on the optical axis of the image capturing optical system, and a polarization optical path splitting element (for example, a birefringent prism, Wollaston prism and the like) that splits the optical path into a plurality according to the property of polarization, are used. The polarization property of incident light is selectively switched by the polarization switching element, and the incident light is directed to one of split optical paths according to the polarization property. That is, a plurality of optical paths are generated according to the switched polarization property.

In the present embodiment, one of the 2 generated optical paths is regarded as the first optical path, and the other optical path is regarded as the second optical path. Thus, the present embodiment is configured so that, without moving the image capturing an image apparatus 50 itself, the optical axis of the image capturing optical system 2 is shifted between the first optical axis and the second optical axis whose image capturing ranges overlap at least partly.

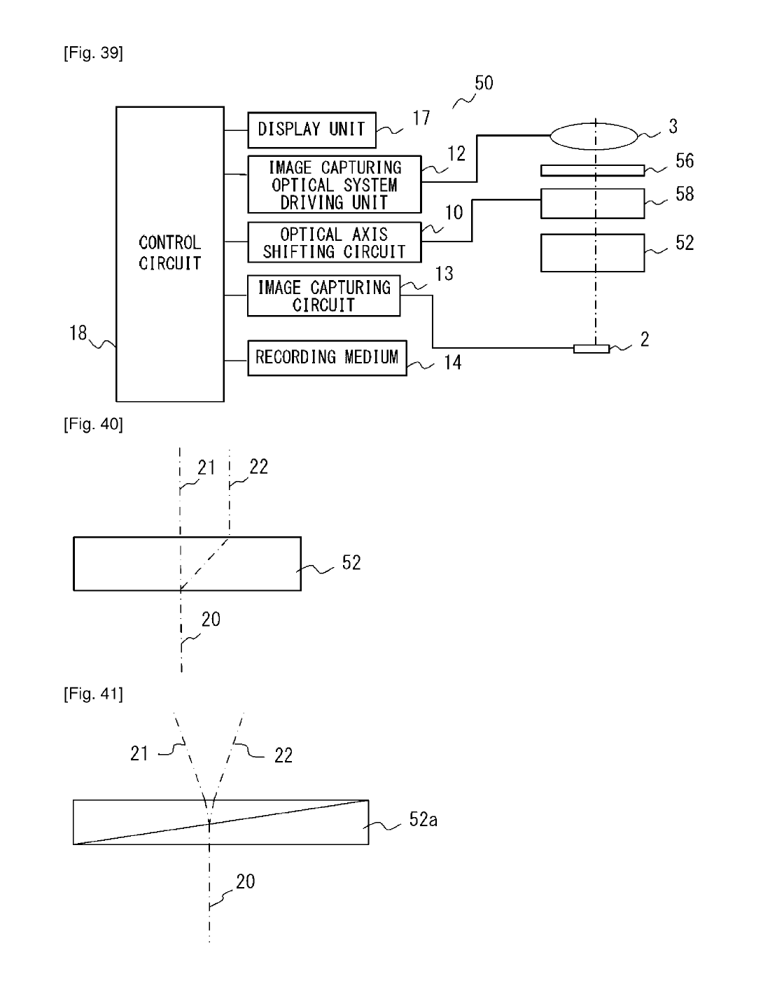

FIG. 39 is a diagram illustrating the sixth embodiment of the present invention. In the figure, the image capturing apparatus 50 has an image capturing element 2, an image capturing optical system 3, an optical axis shifting circuit 10, an image capturing optical system driving unit 12, an image capturing circuit 13, a recording medium 14, a display unit 17, and a control circuit 18. In addition, between the image capturing optical system 3 and the image capturing element 2, a polarization plate 56, a liquid crystal 58 controlled by the optical axis shifting circuit 10, and a polarization optical path splitting element 52 are disposed.

FIG. 40 is a diagram illustrating the birefringence of a calcite and the like as an example of a polarization optical path splitting element. The direction of linear polarization is adopted as the polarization property. The optical axis 20 is separated into the first optical axis 21 and the second optical axis 22 according to the direction of the linear polarization by the birefringent prism which is the polarization optical path splitting element 52.

In addition, FIG. 41 is a diagram presenting a known Wollaston prism 52a as another example of the polarization optical path splitting element 52. The Wollaston prism 52a has a property that separates polarized light rays having orthogonal linear polarization symmetrically, thus the optical axis 20 can be separated into the first optical axis 21 and the second optical axis 22 by the Wollaston prism 52a, for example.

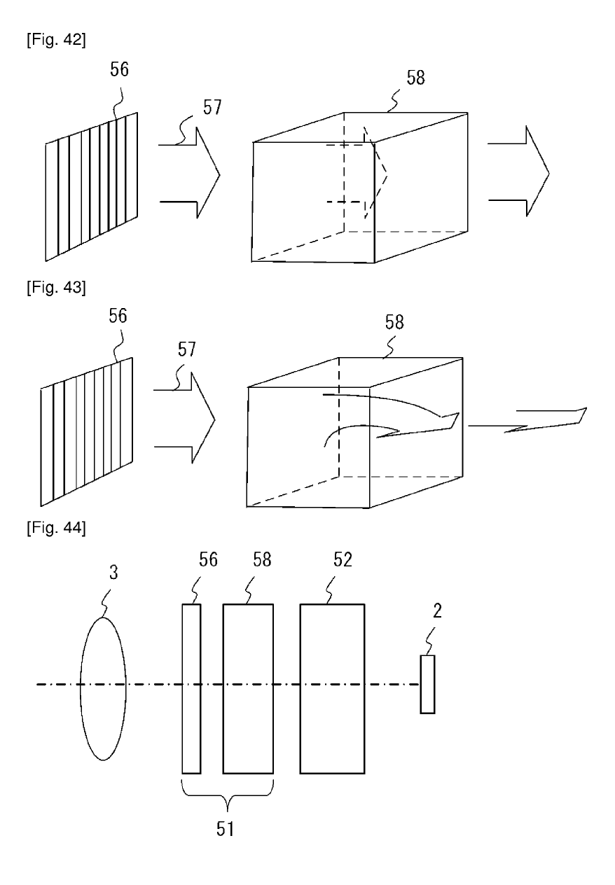

Meanwhile, FIG. 42 and FIG. 43 are diagrams illustrating the operation in which the liquid crystal 58 switches the property of polarization, as an example of the polarization switching element 51. Incident light on the polarization plate 56 exits while being polarized in one direction. When this polarized light 57 enters the liquid crystal 58, in the case in which a voltage is applied to the upper and lower surfaces of the liquid crystal 58, the liquid crystal molecules are aligned along the electric field, and as illustrated in FIG. 42, the polarized light 57 is ejected without change in the polarized direction. On the other hand, in the case in which no voltage is applied to the upper and lower surfaces of the liquid crystal 58, as illustrated in FIG. 43, the liquid crystal molecules are oriented in a twisted direction, and the polarization direction is rotated by the effect of the molecules, then the light exits. The effect of switching the property of polarization can also be obtained with a Faraday rotator.

FIG. 44 presents the arrangement of elements along the optical axis, where, from the subject side, the image capturing optical system 3, the polarization switching element 51 including the polarization plate 56 and the liquid crystal 58, the polarization optical path separation element 52, and the image capturing element 2 are disposed. In this case, the image capturing optical system 3 is disposed closer to the subject with respect to the polarization switching element 51 and the polarization optical path separation element 52, in order to obtain large parallax on the screen even with a small splitting amount of the optical path. However, the polarization switching element 51 and the polarization optical path separation element 52 may be positioned ahead of the image capturing optical system 3 or may be positioned in the middle of the image capturing optical system 3. That is, the polarization switching element 51 and the polarization optical path separation element 52 may be disposed at any position on the side closer to the subject with respect to the image capturing element 2. In addition, either of the polarization switching element 51 and the polarization optical path separation element 52 may be positioned ahead of each other.

In this embodiment, the property of polarization of incident light is switched by converting it into one of 2 linear polarizations having different directions by the polarization switching element 51. The incident light travels in a corresponding path in the plurality of paths split by the polarization optical path splitting element 52 according to the switched property of polarization (direction of the liner polarization). Therefore, it becomes possible to switch the optical axis between the first optical axis and the second optical axis.

Specifically, light incident from the subject is made into linear polarization by the polarization plate 56, and switched alternatively into a first polarization whose polarization plane of the linear polarization does not rotate and a second polarization whose polarization plane is rotated by 90 degrees. When the polarized light incident on the polarization optical axis separation element 52, the Wollaston prism 52a as one example, in the case in which the polarization is the first polarization, the direction of the optical axis 20 is bent to the direction of the optical axis 21 by the Wollaston prism 52a. When the polarization is the second polarization, the direction of the optical axis 20 is bent to the direction of the second optical axis 22. Therefore, by turning on and off the voltage applied to the liquid crystal 58, the optical axis can be shifted between the first optical axis 21 and the second optical axis 22.

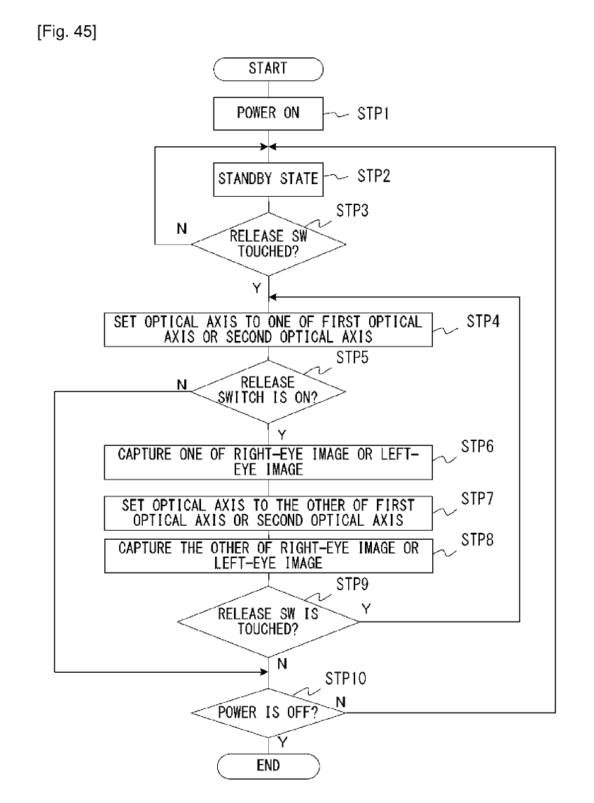

FIG. 45 is a flowchart illustrating a 3-dimensional image capturing method of the present invention. First, in the same manner as illustrated in the process in FIG. 10, the power of the image capturing apparatus 50 is turned on (step (hereinafter, presented as STP)1). In turn on of the power of the image capturing apparatus, power supply to the control circuit 18 and the like is performed by pressing down a power button that is not shown in the drawing, for example.

After that, the image capturing apparatus 1 waits until a finger of the operator touches the release switch (release SW) 23 in the standby mode (STP2, NO in STP3). When the finger of the operator touches the release SW 23 (YES in STP3), the optical axis is set to one of the first optical axis of the second optical axis (STP4). Here, for example, it is assumed that the optical axis is set to the first optical axis. This is done by setting one of the state in which the linear polarization of incident light is rotated by the liquid crystal and the state in which it is not rotated, by controlling the voltage applied to the liquid crystal 58 with the optical axis shifting circuit 10.

Next, whether or not the release SW 23 has been turned on is determined (STP5). That is, from the state in which the finger of the operator touched the release SW23, whether or not the operator further pressed down the release SW 23 is determined. Here, if the operator presses down the release SW 23 (YES in STP5), one of the left eye image and the right eye image is captured (STP6). Meanwhile, in the case in which the operator does not further press down the release SW 23 from the state in which the finger of the operator touched the released SW 23 (NO in STP5), whether or not the power has been turned off is determined (STP10), and as long as the power has not been turned off (NO in STP10), the waiting state for the pressing down of the release SW 23 by the operator is continued (STP4, STP5).

On the other hand, when the operator pressed down the release switch SW 23, as described above, after one of the left eye image or the right eye image is captured, the optical axis is set to the other of the first optical axis and the second optical axis (STP7). This is done by setting a state that is different from the one set in STP4 between the state in which the linear polarization of incident light is rotated by the liquid crystal and the state in which it is not rotated, by controlling the voltage applied to the liquid crystal 58 with the optical axis shifting circuit 10.

Here, for example, it is assumed that the optical axis is set to the second optical axis. Then, the other of the left eye image or the right eye image is captured (STP8).

For example, if the left eye image was taken at the timing when the optical axis of the image capturing optical system 3 was being the first optical axis 21, the right eye image is captured at the timing when the optical axis of the image capturing optical system 3 is being the second optical axis 22. The process is continued as long as the release SW 23 is touched by the operator (YES in STP9), and the left eye image and the right eye image are captured at different timings by time division. The left eye image and the right eye image captured as described above are recorded sequentially in the recording medium 14 as a pair in the same manner as described above.

After that, when the operator removes the finger from the release SW (NO in STP9), whether or not the power of the image capturing apparatus is off is further determined (NO in STP10), and as long as the power of the image capturing apparatus is on (NO in STP10), the waiting state for the pressing down of the release SW 23 by the operator is continued (STP4, STP5), and the process is terminated when the power of the image capturing apparatus is turned off.

Meanwhile, in the same manner as described above, the above process is for the case of capturing moving images, and in the case of capturing a still image, the shift of the first optical axis 21 and the second optical axis 22 finishes with only one time, and image data is recorded in the recording medium 14.

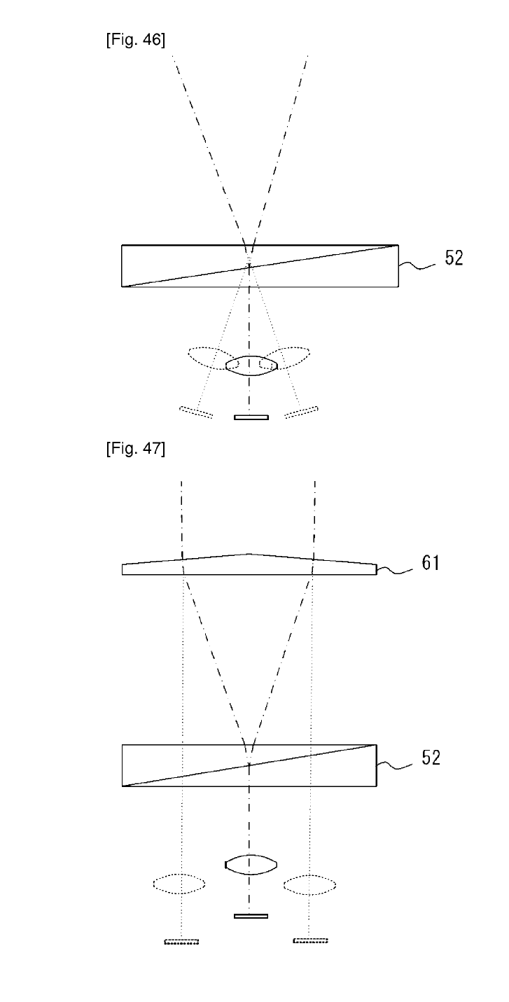

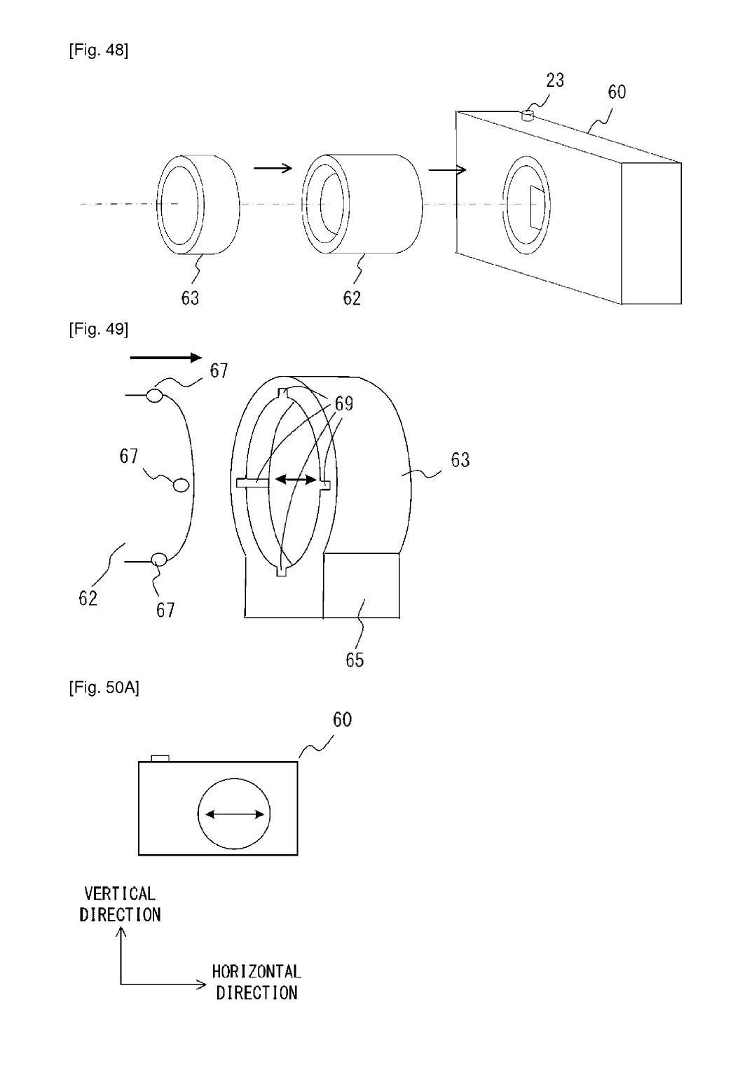

FIG. 46 is an example of capturing a 3-dimensional image by the cross view method by splitting the optical axis 20 into the first optical axis 21 and the second optical axis 22 by the polarization optical path splitting element 52. In addition, FIG. 48 is an example of realizing the parallel view method by placing a light beam bending element 61 between the polarization optical path splitting element 52 and the subject not shown in the drawing, to bend the direction of the light rays, changing the spatial layout of the first optical axis and the second optical axis.

In addition, FIG. 48 is an example in which the attachment and removal of the polarization switching element 51 and the polarization optical path separation element 52 are made easy by placing the polarization switching element 51 and the polarization optical path separation element 52 ahead of the image capturing optical system 3. That is, the configuration is made by attaching a 3-dimensional image capturing adaptor 63 including the polarization switching element 51 and the polarization optical path separation element 52 in front of a replacement lens of an image capturing apparatus 60, to capture a 3-dimensional image.

In addition, FIG. 49 is an example in which the configuration is made so that the replacement lens 62 and the 3-dimensional image capturing adopter 63 rotate smoothly. In this case, the configuration is made so that a weight 65 is provided at the eccentric position of the 3-dimensional image capturing adopter 63, and by the effect of gravity on the weight 65, the 3-dimensional adopter 63 constantly hangs the weight 65 down.

In configuration described above, by making the configuration in advance so that the parallax direction becomes horizontal when the image capturing apparatus 60 is held horizontally, even when the image capturing apparatus 60 is held vertically, the 3-dimensional image capturing adopter 63 turns by 90 degrees by gravity, and the parallax direction is maintained horizontal. FIG. 50A and FIG. 50B are diagram illustrating this. FIG. 50A is the case in which the image capturing apparatus is held horizontally, and FIG. 50B is the case in which the image capturing apparatus is held vertically where the parallax direction in the captured image is shown with a 2-headed arrow. Thus, in either ease, the parallax direction can be maintained horizontal by the turn of the 3-dimensional image capturing adopter 63 by gravity.

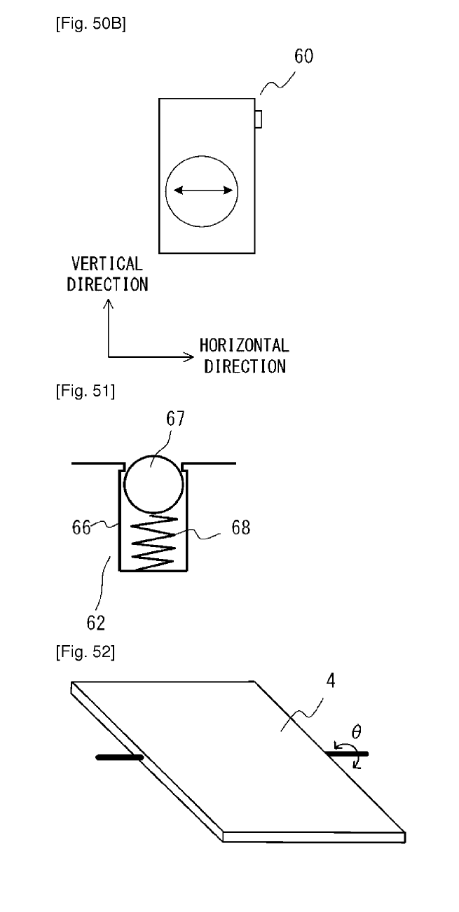

Meanwhile, FIG. 51 is a diagram illustrating the configuration of a clip mechanism used for the rotation of the 3-dimensional image capturing adopter 63. For example, as illustrated in FIG. 49, four grooves 69 are provided in the 3-dimensional image capturing adopter 63, and a roller 67 that intrudes into the grooves is disposed on the replacement lens 62 side, to configure the 3-dimensional image capturing adopter 63 as rotatable with respect to the replacement lens 62. Therefore, as illustrated in FIG. 51, the structure is made so that the roller 67 intrudes into the grooves 66 provided on the circumference of the replacement lens 62 via an elastic member 68 such as a spring, to be rotatable and not to fall out of the grooves 66. By this structure, the 3-dimensional image capturing adopter 63 turns with appropriate smoothness with respect to the replacement lens 62. That is, when the direction in which the image capturing apparatus 60 is held is switched between horizontal and vertical, the 3-dimensional image capturing adopter 63 turns with respect to the replacement lens 62. However, with a slight movement of the image capturing apparatus 60, the 3-dimensional image capturing adopter 63 does not turn with respect to the replacement lens 62.

### Seventh Embodiment

Next, the seventh embodiment of the present invention is explained.

In each of the embodiments described above, the optical axis of one image capturing optical system of an image capturing apparatus is shifted between a first optical axis and a second optical axis without moving the image capturing apparatus itself, and an image is captured twice at the timing when the optical axis becomes the first optical axis and at the timing when the optical axis becomes the second optical axis. In the seventh embodiment, the optical axis of the image capturing optical system is swung along a plane, and image capturing is performed also at timing other than the timing when the optical axis of the image capturing optical system becomes the first optical axis and the timing when it becomes the second optical axis. That is, during the shift of the optical axis, image capturing is performed more than twice.

Meanwhile, while the optical axis shifting mechanism and the timing of image capturing is mainly explained in this embodiment, the combination of the optical layout setting mechanism explained in other embodiments with the configuration of the present embodiment can be easily implemented by those skilled in the art.

The present embodiment basically uses the configuration disclosed in FIG. 2 described above. Hereinafter, only the characteristic parts of the present embodiments are explained.

FIG. 52 presents the first optical axis deflecting member 4 being a reflective member whose surface is an optical reflective surface (such as an aluminum-coated mirror and a multilayer reflective mirror) as disclosed in FIG. 2. The optical axis shifting circuit 10 makes the first optical axis deflecting member 4 vibrate around the axis in the angle range from

+θ to −θ.

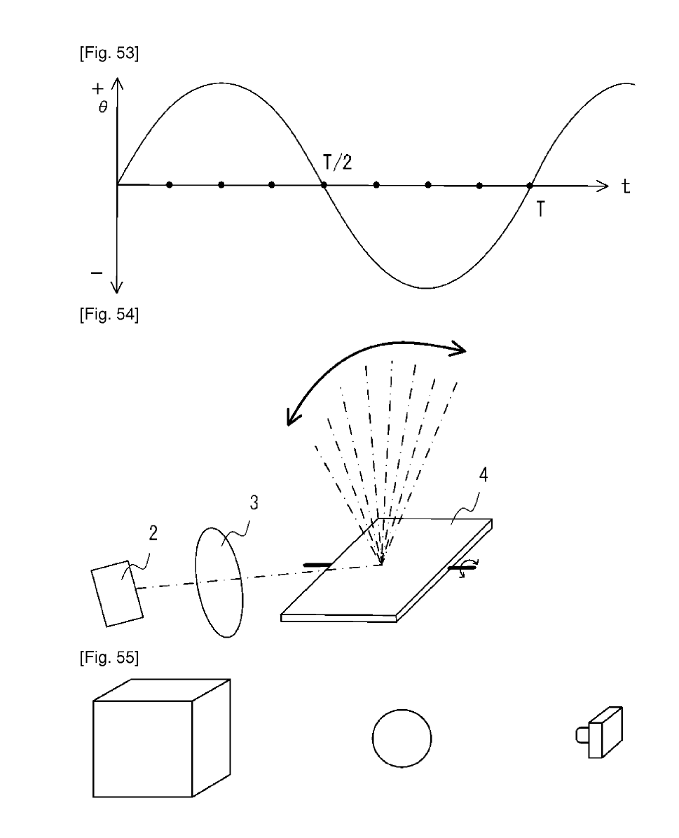

Meanwhile, FIG. 53 is a time series graph of changes of the angle of the first optical axis deflecting member 4, where the vibration cycle is shown as T. Here, the image capturing circuit 13 performs image capturing more than twice during the vibration cycle T. In this embodiment, image capturing is performed once every predetermined period of T/8. That is, image capturing is performed at the timing of ⅛, 2/8, ⅜, 4/8, ⅝, 6/8, ⅞, 8/8 of T in one cycle T. Meanwhile, the timings of image capturing are shown with black circles.

FIG. 54 is an oblique perspective view presenting image capturing in the present embodiment schematically. The optical axis at the timing when image capturing is performed is shown with a dot-and-broken line.

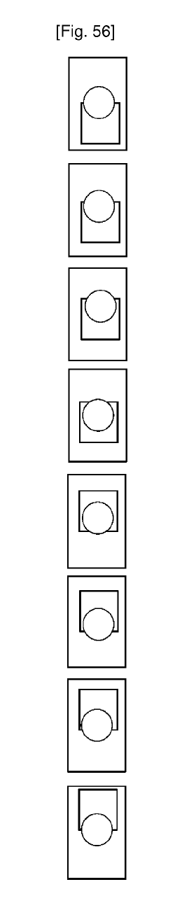

FIG. 55 is a diagram presenting the situation of capturing an image of a configuration having a cube in a distant view and a sphere in a near view by the image capturing apparatus of the present embodiment. FIG. 56 is images shot in the above situation by the image capturing apparatus of the present embodiment. Since image capturing is performed eight times in one cycle, eight pieces of captured images obtained. In each captured image, a sphere appears on the foreground, and a cube appears on the background. As is apparent from the figure, these images are parallax images having parallax with each other, and furthermore, the amount of parallax is presented with a plurality of stages.

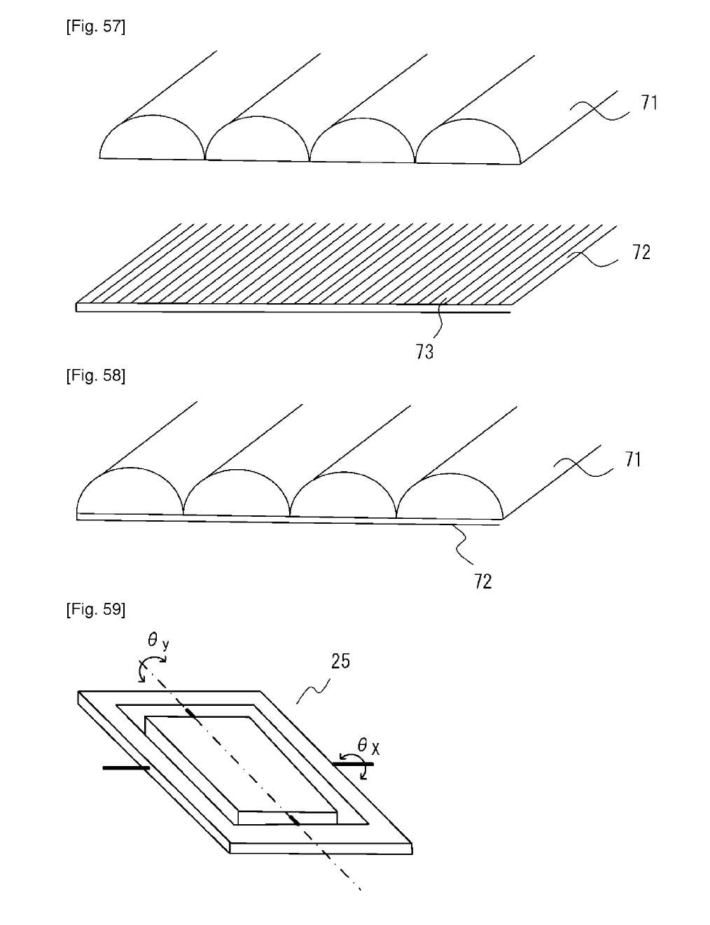

FIG. 57 is a diagram illustrating the manner in which the plurality of parallax images described above are observed using a known lenticular technique. In FIG. 57, a base material 72 with an observation pattern printed on its upper surface is disposed below a lenticular lens. In the observation pattern, a plurality of striped area 73 are juxtaposed, and images in which the eight images having different parallax amount from each other captured by the image capturing apparatus and contracted only in the horizontal direction are printed in each striped area 73. The lenticular lens 71 and the base material 72 are joined with position adjustment as presented in FIG. 58. When an observer observes the lenticular lens 71 from above in this state, images having different parallax according to the viewing angle are observed while enlarged only in the horizontal direction by the lenticular lens 71. Since the images are contracted in the horizontal direction in advance, by the enlargement of the lenticular lens 71 in the horizontal direction, observation is performed at the aspect ratio of the original image.

In this embodiment, an image selected according to the viewing angle of the observer is observed from a plurality of (more than 2) images having different parallax with each other. Therefore, expression can be made so that stereoscopic effects change according to changes in the observation angle.

Meanwhile, the similar effect as the present embodiment can be obtained also in FIG. 14 explained above, by performing image capturing more than twice in one cycle in the same manner as described above, in the vibration of the cylindrical first optical axis deflecting member 31, or the image capturing unit, around the axis.

### Eighth Embodiment

Next, the eighth embodiment of the present invention is explained.

In the seventh embodiment described above, image capturing is performed more than twice during one round of the shift of the optical axis around the axis, and the optical axis at the time of image capturing is radially distributed on a fan-shaped plane. Meanwhile, in the eighth embodiment, the optical axis of the image capturing optical system is rotated cyclically around a different axis other than optical axis. As a result, the trajectory of the optical axis of the image capturing apparatus becomes conic or cylindrical. That is, the optical axis rotates along the lateral surface of a circular cone or a cylinder. Then, image capturing is also performed at timing other than the timing when the optical axis of the image capturing optical system becomes the first optical axis and the timing when it becomes the second optical axis. In this embodiment, the shift of optical axis is performed around 2 axes, to make the optical axis perform precession and to obtain a group of images having parallax in a plurality of directions.

Meanwhile, while the optical axis shifting mechanism and the timing of image capturing is mainly explained in this embodiment, the combination of the optical layout setting mechanism explained in other embodiments with the configuration of the present embodiment can be easily implemented by those skilled in the art.

The present embodiment basically uses the configuration disclosed in FIG. 2 described above. Hereinafter, only the characteristic parts of the present embodiments are explained.

FIG. 59 presents the first optical axis deflecting member 25 being a reflective member that vibrates with 2 axes disclosed in FIG. 12 above. The first optical axis deflecting member 25 has 2 axes of X and Y, and vibrates around each axis in the angle range from

+θ to −θ.

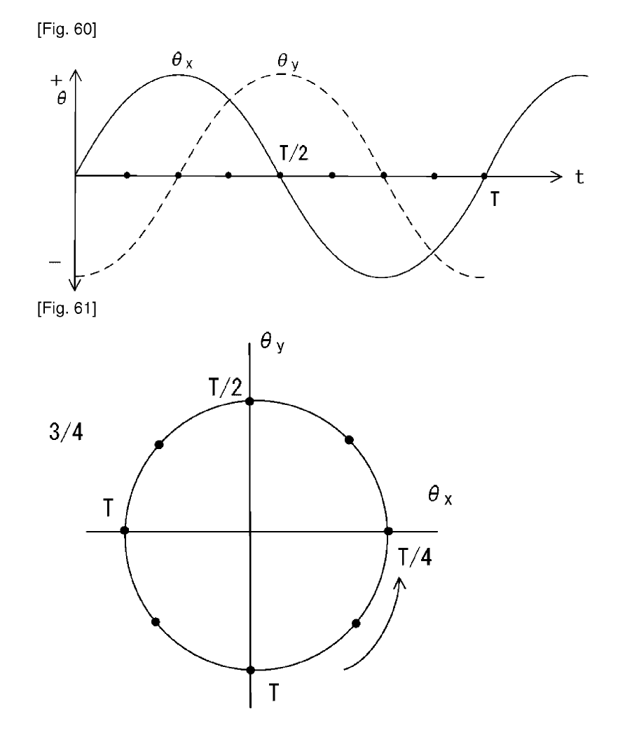

FIG. 60 presents the relationship between the vibration phase around the X axis and the vibration phase around the Y axis of the first optical axis deflecting member 25 realized by the optical axis shifting circuit 10. While the cycles T of vibration are the same as each other, the phases of vibration are shifted relatively by 90 degrees. In such a vibration state, the image capturing circuit 13 performs image capturing more than twice during the vibration cycle T. In this embodiment, image capturing is performed once every predetermined period of T/8. That is, image capturing is performed at the timing of ⅛, 2/8, ⅜, 4/8, ⅝, 6/8, ⅞, 8/8 of T in one cycle T. Meanwhile, the timing of image capturing is shown with a black circle in FIG. 60.

FIG. 61 a diagram in which the timing of the image capturing is plotted on the

θx−θy

plane. In addition, the timing of image capturing is shown with a black circle, and each black circle is on a circumference. Therefore, it is understood that the reflective surface of the first optical axis deflecting member 25 moves so that the trajectory of the perpendicular line draws the lateral surface of a circular cone. In fact, the shape of the cone is not limited to the circular cone, as when the maximum degrees of swing of

θx and θy

are made to be different, a lateral surface of an ellipsoidal cone is drawn.

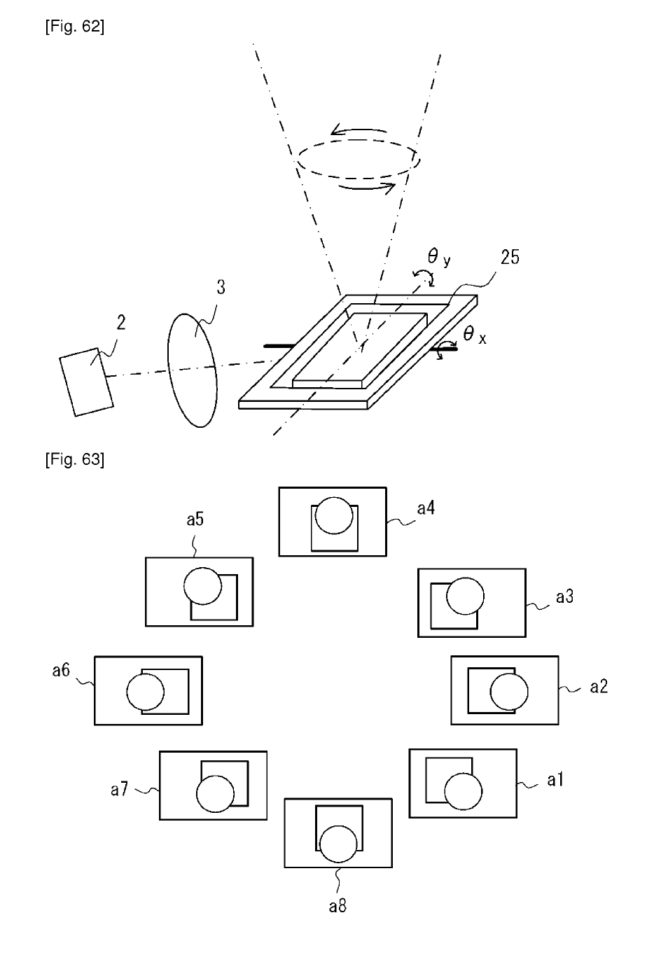

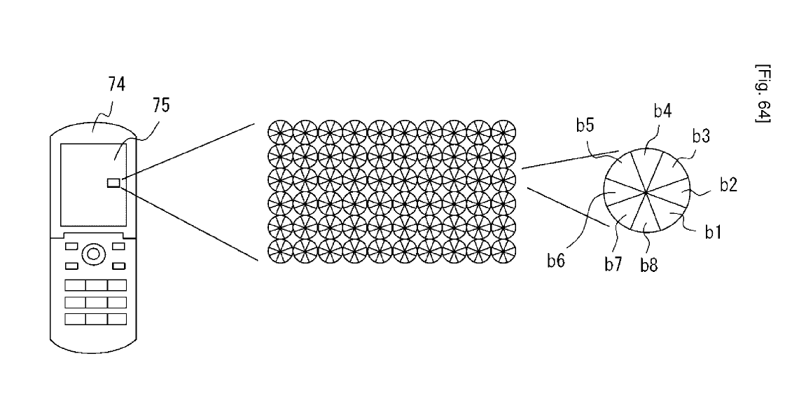

FIG. 62 is a diagram presenting the shift of the optical axis, showing that according to the movement of the reflective surface, the optical axis performs precession. FIG. 63 presents a captured image in which, in the precession of the optical axis, image capturing is performed one every T/8 period by the image capturing circuit 13.

In addition, images a1-a8 presented in FIG. 63 are the ones shot in the same setting as for FIG. 55 described above. In each captured image, a sphere appears on the foreground, and a cube appears on the background. As is apparent from the figure, these images are parallax images having a parallax with each other, and furthermore, the direction of parallax is different in each picture.

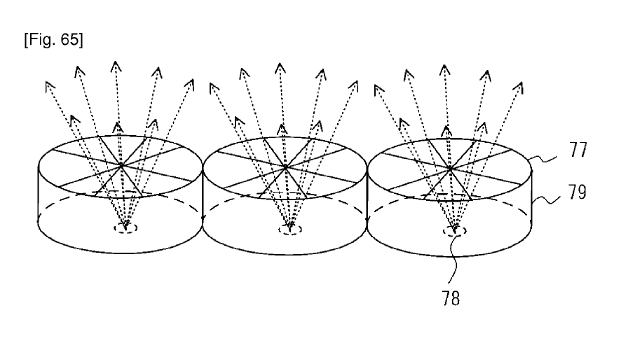

Furthermore, FIG. 64 presents an apparatus (a mobile phone is presented in the figure) having a display 75 to observe the image presented in FIG. 63 mentioned above. In the display 75, pixels are arranged in a 2-dimensional array, and each pixel has a light transmission layer in which a plurality of sub pixels that modulate at least one of the spectrum or intensity of transmitted light are arrayed point-symmetrically. In this embodiment, each pixel has eight sub pixels b1 to b8. In this display, the images a1-a8 presented in FIG. 63 mentioned above are associated respectively with, and displayed on, the eight sub pixels b1 to b8.

While a mobile phone 74 is illustrated here as an apparatus having the display 75, other than that, the apparatus may be, but is not limited to, a TV, a personal computer (PC), a mobile information terminal, a monitor and the like.

FIG. 65 presents the configuration of each pixel. Below a layer 77 in which the pixels are provided, a light source 78 having a smaller or equal area than the area of each sub pixel is provided. The light source 78 is positioned immediately below the center of a pixel (the symmetrical point of the sub pixels). In addition, a light shielding member 79 is provided in each pixel so that light from other pixels does not enter. In this configuration, luminous flux emitted from the light source 78 reaches the eyes of the observer while passing through either one of the respective sub pixels. Which sub pixel the light that reaches the eyes of the observer passes through is determined by from which direction the observer observes the display 75. Accordingly, regardless of whether the observer's head is held upright, inclined, or horizontally with respect to the upright display 75, a parallax image captured in the direction corresponding to each attitude can be observed. Thus, the present embodiment enables observation of a 3-dimensional image with a high degree of freedom of attitude with respect to the display.

In addition, even when the display presented in FIG. 64 and FIG. 65 are not used, observation of a 3-dimensional image can be performed (by using a 3D glasses and the like) by selecting a pair from pairs of images whose image capturing timings are shifted by T/2 (in this embodiment, a1 and a5, a2 and a6, a3 and a7, a4 and a8), and displaying it on the display so as to make the parallax horizontal. Therefore, according to the image capturing apparatus of the embodiment, a 3-dimensional image can always be displayed in the state in which fusion of images is enabled, by selecting an appropriate pair of images at the time of the display, regardless of whether the image was captured while holding the image capturing apparatus horizontally, or the image was captured while holding the image capturing apparatus vertically.

Meanwhile, the similar effect as the present embodiment can be obtained also in FIG. 14 explained above, by making precession and performing image capturing more than twice in one cycle in the same manner as described above, in the vibration of the cylindrical first optical axis deflecting member 31, which is the image capturing unit, around the axis. In addition, the similar effect as the present embodiment can be obtained also in FIG. 20 and FIG. 28, by performing image capturing more than twice during one rotation of the rotation unit. In this case, the trajectory of the optical axis becomes cylindrical when the optical axis extending from the rotation unit is parallel to the rotation axis, and it becomes conic when they are not parallel.

As described above, according to each of the embodiments described above, since a 3-dimensional image can be obtained while shifting the optical axis in a monocular system and capturing the left eye image and the right eye image by time division, only one image capturing optical system is required, making it possible to reduce the production cost. In addition, since there is no need for matching properties and control of binocular optical systems, the production becomes easy, and mounting of a high-performance optical system and a zoom optical system that has been difficult with the binocular system also becomes easy.

In addition, the optical layout setting mechanism disclosed in some of the embodiments described above can be effectively mounted on a conventional binocular 3-dimensional image capturing apparatus. In that case, for example, the configuration may be made so that 2 image capturing optical systems of the binocular image capturing apparatus are connected by an actuator, and the relative angle of the 2 image capturing optical system are changed by driving the actuator.

1. A 3-dimensional image capturing method for capturing a 3-dimensional image including a left eye image and a right eye image that are 2-dimensional images having parallax with each other using an image capturing apparatus, comprising:
shifting, without moving the image capturing apparatus itself, an optical axis of an image capturing optical system of the image capturing apparatus between a first optical axis and a second optical axis whose image capturing ranges overlap at least partly, wherein in the shift,
capturing one of the left eye image and the right eye image at timing when the optical axis of the image capturing optical system is being the first optical axis; and
capturing the other of the left eye image and the right eye image at timing when the optical axis of the image capturing optical system is being the second optical axis.

2. The 3-dimensional image capturing method according to claim 1, wherein the shift of the optical axis of the image capturing optical system between the first optical axis and the second optical axis is performed by moving an optical axis deflecting member disposed on the optical axis of the image capturing optical system to change a direction of an optical axis.

3. The 3-dimensional image capturing method according to claim 2, wherein
the optical axis deflecting member is a reflective member.

4. The 3-dimensional image capturing method according to claim 1, wherein the shift of the optical axis of the image capturing optical system between the first optical axis and the second optical axis is performed by moving an orientation of the image capturing optical system.

5. The 3-dimensional image capturing method according to claim 1, wherein the shift of the optical axis of the image capturing optical system between the first optical axis and the second optical axis is performed by moving a position of the image capturing optical system.

6. The 3-dimensional image capturing method according to claim 1, wherein
on the optical axis of the image capturing optical system, a polarization switching element to switch a polarization property of incident light and a polarization optical path splitting element to split an optical path into a plurality according to a property of polarization are disposed, and the shift of the optical axis of the image capturing optical system between the first optical axis and the second optical axis is performed by switching polarization property by the polarization switching element.

7. The 3-dimensional image capturing method according to claim 6, wherein
the polarization switching element switches a polarization direction of linear polarization, and
the polarization optical path splitting element splits an optical path according to a polarization direction of linear polarization.

8. The 3-dimensional image capturing method according to claim 1, further comprising:
Setting a spatial layout of the first optical axis and the second optical axis by changing a relative angle of the first optical axis and the second optical axis.

9. The 3-dimensional image capturing method according to claim 8, wherein
the spatial layout of the first optical axis and the second optical is set, so that a layout of the first optical axis and the second optical axis is in a relationship of a cross view method.

10. The 3-dimensional image capturing method according to claim 8, wherein
the spatial layout of the first optical axis and the second optical is set, so that a layout of the first optical axis and the second optical axis is in a relationship of a parallel view method.

11. The 3-dimensional image capturing method according to claim 8, wherein
the spatial layout of the first optical axis and the second optical is set, so that a layout of the first optical axis and the second optical axis is a V-shape.

12. The 3-dimensional image capturing method according to claim 8, wherein
in setting the spatial layout of the first optical axis and the second optical axis, a special layout to be set varies according to a distance from the image capturing apparatus to a subject.

13. The 3-dimensional image capturing method according to claim 8, wherein
setting of the spatial layout of the first optical axis and the second optical axis is performed by setting an orientation of an optical axis deflecting member disposed on the optical axis of the image capturing optical system to change a direction of an optical axis.

14. The 3-dimensional image capturing method according to claim 13, wherein
the optical axis deflecting member is a reflective member.

15. The 3-dimensional image capturing method according to claim 1, wherein
the shift is to swing the optical axis of the image capturing optical system along a plane, and image capturing is also performed at timing other than timings when the optical axis of the image capturing optical system becomes the first optical axis and the second optical axis.

16. The 3-dimensional image capturing method according to claim 1, wherein
the shift is to swing the optical axis of the image capturing optical system along a lateral surface of a cone, and image capturing is also performed at timing other than timings when the optical axis of the image capturing optical system becomes the first optical axis and the second optical axis.

17. A 3-dimensional image capturing apparatus for capturing a 3-dimensional image including a left eye image and a right eye image that are 2-dimensional images having parallax with each other, comprising:
an image capturing optical system;
an image capturing element on which light passing through the image capturing optical system forms an image;
an optical axis shifting mechanism to shift, without moving the image capturing apparatus itself, an optical axis of the image capturing optical system between a first optical axis and a second optical axis whose image capturing ranges overlap at least partly; and
an image capturing circuit to capture one of the left eye image and the right eye image at timing when the optical axis of the image capturing optical system is being the first optical axis and to capture the other of the left eye image and the right eye image at timing when the optical axis of the image capturing optical system is being the second optical axis.

18. The 3-dimensional image capturing apparatus according to claim 17, wherein
the optical axis shifting mechanism has an optical axis deflecting member disposed on the optical axis of the image capturing optical system to change a direction of an optical axis, and a driving unit to switch an orientation of the optical axis deflecting member, and the optical axis shifting mechanism makes the optical axis of the image capturing optical system shift between the first optical axis and the second optical axis by switching the orientation of the optical axis deflecting member by the driving unit.

19. The 3-dimensional image capturing apparatus according to claim 18, wherein
the optical axis deflecting member is a reflective member.

20. The 3-dimensional image capturing apparatus according to claim 17, comprising, as the optical axis shifting mechanism, a driving unit to switch an orientation of the image capturing optical system, wherein the shift of the optical axis of the image capturing optical system between the first optical axis and the second optical axis is performed by switching the orientation of the image capturing optical system by the driving unit.

21. The 3-dimensional image capturing apparatus according to claim 17, comprising, as the optical axis shifting mechanism, a driving unit to switch an position of the image capturing optical system, wherein the shift of the optical axis of the image capturing optical system between the first optical axis and the second optical axis is performed by switching the position of the image capturing optical system by the driving unit.

22. The 3-dimensional image capturing apparatus according to claim 17, wherein the optical axis shifting mechanism has, on the optical axis of the image capturing optical system, a polarization switching element to switch a polarization property of incident light, and a polarization optical path splitting element to split an optical path into a plurality according to a property of polarization, and
the shift of the optical axis of the image capturing optical system between the first optical axis and the second optical axis is performed by switching polarization property by the polarization switching element.

23. The 3-dimensional image capturing apparatus according to claim 22, wherein
the polarization switching element switches a polarization direction of linear polarization, and
the polarization optical path splitting element splits an optical path according to a polarization direction of linear polarization.

24. The 3-dimensional image capturing apparatus according to claim 17, further comprising an optical axis layout setting mechanism to set a spatial layout of the first optical axis and the second optical axis by changing a relative angle of the first optical axis and the second optical axis.

25. The 3-dimensional image capturing apparatus according to claim 24, wherein
the optical axis layout setting mechanism performs setting so that a layout of the first optical axis and the second optical axis becomes a relationship of a cross view method.

26. The 3-dimensional image capturing apparatus according to claim 24, wherein
the optical axis layout setting mechanism performs setting so that a layout of the first optical axis and the second optical axis becomes a relationship of a parallel view method.

27. The 3-dimensional image capturing apparatus according to claim 24, wherein
the optical axis layout setting mechanism performs setting so that a layout of the first optical axis and the second optical axis becomes a V-shape.

28. The 3-dimensional image capturing apparatus according to claim 24, wherein
the optical axis layout setting mechanism sets a layout of the first optical axis and the second optical axis to a different layout according to a distance from the image capturing apparatus to a subject.

29. The 3-dimensional image capturing apparatus according to claim 24, wherein
the optical axis layout setting mechanism sets a layout of the first optical axis and the second optical axis by setting an orientation of an optical axis deflecting member disposed on the optical axis of the image capturing optical system to change a direction of an optical axis.

30. The 3-dimensional image capturing apparatus according to claim 29, wherein
the optical axis deflecting member is a reflective member.

31. The 3-dimensional image capturing apparatus according to claim 17, wherein
the optical axis shifting mechanism makes the optical axis of the image capturing optical system swing along a plane; and
the image capturing circuit also performs image capturing at timing other than timings when the optical axis of the image capturing optical system becomes the first optical axis and the second optical axis.

32. The 3-dimensional image capturing apparatus according to claim 17, wherein
the optical axis shifting mechanism makes the optical axis of the image capturing optical system rotate around a different axis other than the optical axis; and
the image capturing circuit also performs image capturing at timing other than timings when the optical axis of the image capturing optical system becomes the first optical axis and the second optical axis.

33. A 3-dimensional image capturing apparatus for capturing a 3-dimensional image including a plurality of 2-dimensional images having parallax with each other, comprising:
an image capturing optical system;
an image capturing element on which light passing through the image capturing optical system forms an image;
an optical axis shifting mechanism to cyclically make the optical axis of the image capturing optical system swing without moving the image capturing apparatus itself; and
an image capturing circuit to perform image capturing at least twice during one cycle of swing of the optical axis.

34. A 3-dimensional image capturing apparatus for capturing a 3-dimensional image including a left eye image and a right eye image that are 2-dimensional images having parallax with each other, comprising:
a monocular or binocular image capturing optical system having a first optical axis for capturing one of a left eye image and a right eye image and a second optical axis for capturing the other of a left eye image and a right eye image;
an optical axis layout setting mechanism to change a relative angle of the first optical axis and the second optical axis of the image capturing optical system; and
an image capturing circuit to capture one of the left eye image and the right eye image with the first optical axis and to capture the other of the left eye image and the right eye image with the second optical axis.

35. A 3-dimensional image capturing apparatus for capturing a 3-dimensional image including a plurality of 2-dimensional images having parallax with each other, comprising:
an image capturing optical system;
an image capturing element on which light passing through the image capturing optical system forms an image;
an optical axis shifting mechanism to cyclically make the optical axis of the image capturing optical system rotate around a different axis other than the optical axis without moving the image capturing apparatus itself; and
an image capturing circuit to perform image capturing a plurality of times during one cycle of rotation movement of the optical axis.

36. A display in which a plurality of pixels are arrayed 2-dimensionally, comprising:
a light-transmission layer on which a plurality of sub pixels of the pixels that modulate at least one of a spectrum and intensity of transmitted light are arrayed point-symmetrically; and
a light source disposed below the symmetrical point whose light-emitting area is not larger than the sub pixel.
